(19) United States
(12) Patent Application Publication
(10) Pub. No.: US 2008/0180816 A1
(43) Pub. Date: Jul. 31, 2008

(54) Imaging lens and imaging device including the imaging lens

(75) Inventor: Akira Nakamura, Kawaguchi-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Enplas Corporation

(21) Appl. No.: 12/011,895

(22) Filed: Jan. 30, 2008

(30) Foreign Application Priority Data
Jan. 31, 2007 (JP) 2007-020691

(51) Int. Cl. G02B 9/34

(52) U.S. Cl. 359/773

(57) ABSTRACT

It is to provide an imaging lens and an imaging device including the imaging lens in which the imaging lens can maintain excellent optical performance, while achieving sufficient reduction in size and weight.

The imaging lens comprises, in order from an object side to an image surface side, a diaphragm, a first lens that is a biconvex lens having a positive power, a second lens having a negative power, a third lens having a positive power, and a fourth lens that is a biconcave lens, wherein a condition expressed by 0.7≦FL/f₁≦3.0 (where, FL: focal distance of the entire lens system, and f₁: focal distance of the first lens) is to be satisfied.

### BACKGROUND OF THE INVENTION

1. Field of the Invention

The present invention relates to an imaging lens and an imaging device including the imaging lens. In particular, the present invention relates to an imaging lens and an imaging device including the imaging lens, in which the imaging lens has a four-lens structure that is suitable for forming an image of an object on an image-taking surface of an image sensor element, such as a charge-coupled device (CCD) and a complementary metal oxide semiconductor (CMOS), mounted on a portable computer, a television phone, a portable phone, a digital camera, a monitoring camera for a vehicle, and the like.

2. Description of the Related Art

In recent years, there has been an increasing demand for cameras that utilize an image sensor element (solid image sensor element), such as the CCD and the CMOS, that is mounted on a portable computer, a television phone, a portable phone, a digital camera, a monitoring camera for a vehicle, and the like. It is demanded that a camera such as this is small and light because the camera is required to be mounted on a limited installation space.

The image sensor element mounted on a camera such as those mentioned above is mainly a solid image sensor element having a resolution of about 110-thousand pixels, called common intermediate format (CIF), or a solid image sensor element having a resolution of about 300-thousand pixels, called video graphics array (VGA). However, a solid image sensor element having a higher resolution exceeding one million pixels is also recently being used.

Therefore, it is also necessary for the imaging lens used in such cameras to be similarly small and light and to similarly have a high resolution. Conventionally, a four-lens structure lens system using four lenses, such as those described in Patent Literature 1 and Patent Literature 2, is used to meet these demands.

### [Patent Literature 1] Japanese Patent Unexamined Publication Heisei 1-307714

### [Patent Literature 2] Japanese Patent Unexamined Publication 2002-365529

However, in the lens system described in Patent Literature 1, a first lens is a meniscus lens whose convex surface faces an object side. Therefore, power is difficult to gain, and the lens system is not suitable for size and weight reduction.

In the lens system described in Patent Literature 2, a fourth lens is shaped having a convex surface on an object side. Therefore, regardless of a negative power of the fourth lens being weak, an incidence angle of off-axis light incident on the object side face of the fourth lens increases. As a result, a problem in optical performance occurs in that astigmatism increases. An outer diameter of the lens increases. As a result, the lens system is not suitable for size and weight reduction.

### SUMMARY OF THE INVENTION

The present invention has been achieved in light of the above-described problems. An object of the invention is to provide an imaging lens and an imaging device including the imaging lens in which the imaging lens can maintain excellent optical performance, while achieving sufficient reduction in size and weight.

In order to achieve the aforementioned object, an imaging lens according to a first aspect of the present invention is an imaging lens comprising, in order from an object side to an image surface side: a diaphragm, a first lens that is a biconvex lens having a positive power, a second lens having a negative power, a third lens having a positive power, and a fourth lens that is a biconcave lens having a negative power, wherein a condition expressed by the following expression (1) is to be satisfied:

0.7≦FL/f₁≦3.0 (1)

where,

FL: focal distance of the entire lens system

f₁: focal distance of the first lens.

In the first aspect of the invention, a simple quadruple lens structure having a small number of lenses is used. In addition, the condition expressed by the expression (1) is satisfied. Therefore, an outer diameter and an overall length of the lens system can be shorted, aberration can be effectively controlled, telecentricity can be maintained, and a required back focus distance can be secured.

An imaging lens according to a second aspect is the imaging lens according to the first aspect, wherein, further, a condition expressed by a following expression (2) is to be satisfied:

0.3≦FL/|f₂|≦2.8 (2)

where,

|f₂|: absolute value of the focal distance of the second lens.

In the second aspect of the present invention, further, the expression (2) is satisfied. Therefore, aberration, such as field curvature can be more effectively controlled, telecentricity can be maintained with more certainty, and the required back focus distance can be secured with more certainty.

An imaging lens according to a third aspect is the imaging lens according to the first aspect, wherein, further, a condition expressed by a following expression (3) is to be satisfied:

1.3≦FL/|f₄|≦2.5 (3)

where,

|f₄|: absolute value of the focal distance of the fourth lens.

In the third aspect of the invention, further, the expression (3) is satisfied. Therefore, field curvature and distortion can be more effectively controlled, while maintaining telecentricity and securing the required back focus distance.

An imaging lens according to a fourth aspect is the imaging lens according to the first aspect, wherein, further, a condition expressed by a following expression (4) is to be satisfied:

0.3≦(r₇+r₈)/(−r₇+r₈)≦1.2 (4)

where,

r₇: center radius curvature of the object side face of the fourth lens

r₈: center radius curvature of the image surface side face of the fourth lens.

In the fourth aspect of the present invention, further, the expression (4) is satisfied. Therefore, telecentricity can be maintained with more certainty, and a well-balanced control of astigmatism and field curvature can be achieved.

An imaging device according to a fifth aspect of the invention includes the imaging lens according to any one of the first to fourth aspects and an image sensor element.

In the fifth aspect of the present invention, the outer diameter and the overall length of the lens system can be shorted, aberration can be effectively controlled, telecentricity can be maintained, and the required back focus distance can be secured.

### EFFECT OF THE INVENTION

In the imaging lens of the invention, an excellent optical performance can be maintained, while sufficiently reducing the size and weight. In particular, various aberrations can be controlled and telecentricity can be maintained, while having high resolution. In addition, the required back focus distance can be secured.

### BRIEF DESCRIPTION OF THE DRAWINGS

FIG. 1 is a schematic diagram for showing an embodiment of an imaging lens and an imaging device including the imaging lens according to the present invention;

FIG. 2 is a schematic diagram for showing a FIRST EXAMPLE of the imaging lens according to the present invention;

FIG. 3 shows graphs for describing the spherical aberration, astigmatism, and distortion of the imaging lens shown in FIG. 2;

FIG. 4 is a schematic diagram for showing a SECOND EXAMPLE of the imaging lens according to the present invention;

FIG. 5 shows graphs for describing the spherical aberration, astigmatism, and distortion of the imaging lens shown in FIG. 4;

FIG. 6 is a schematic diagram for showing a THIRD EXAMPLE of the imaging lens according to the present invention;

FIG. 7 shows graphs for describing the spherical aberration, astigmatism, and distortion of the imaging lens shown in FIG. 6;

FIG. 8 is a schematic diagram for showing a FOURTH EXAMPLE of the imaging lens according to the present invention;

FIG. 9 shows graphs for describing the spherical aberration, astigmatism, and distortion of the imaging lens shown in FIG. 8;

FIG. 10 is a schematic diagram for showing a FIFTH EXAMPLE of the imaging lens according to the present invention;

FIG. 11 shows graphs for describing the spherical aberration, astigmatism, and distortion of the imaging lens shown in FIG. 10;

FIG. 12 is a schematic diagram for showing a SIXTH EXAMPLE of the imaging lens according to the present invention;

FIG. 13 shows graphs for describing the spherical aberration, astigmatism, and distortion of the imaging lens shown in FIG. 12;

FIG. 14 is a schematic diagram for showing a SEVENTH EXAMPLE of the imaging lens according to the present invention;

FIG. 15 shows graphs for describing the spherical aberration, astigmatism, and distortion of the imaging lens shown in FIG. 14;

FIG. 16 is a schematic diagram for showing an EIGHTH EXAMPLE of the imaging lens according to the present invention;

FIG. 17 shows graphs for describing the spherical aberration, astigmatism, and distortion of the imaging lens shown in FIG. 16;

FIG. 18 is a schematic diagram for showing a NINTH EXAMPLE of the imaging lens according to the present invention; and

FIG. 19 shows graphs for describing the spherical aberration, astigmatism, and distortion of the imaging lens shown in FIG. 18.

FIG. 20 is a schematic diagram for showing a TENTH EXAMPLE of the imaging lens according to the present invention;

FIG. 21 shows graphs for describing the spherical aberration, astigmatism, and distortion of the imaging lens shown in FIG. 20.

FIG. 22 is a schematic diagram for showing a ELEVENTH EXAMPLE of the imaging lens according to the present invention;

FIG. 23 shows graphs for describing the spherical aberration, astigmatism, and distortion of the imaging lens shown in FIG. 22.

FIG. 24 is a schematic diagram for showing a TWELFTH EXAMPLE of the imaging lens according to the present invention;

FIG. 25 shows graphs for describing the spherical aberration, astigmatism, and distortion of the imaging lens shown in FIG. 24.

FIG. 26 is a schematic diagram for showing a THIRTEENTH EXAMPLE of the imaging lens according to the present invention;

FIG. 27 shows graphs for describing the spherical aberration, astigmatism, and distortion of the imaging lens shown in FIG. 26.

FIG. 28 is a schematic diagram for showing a FOURTEENTH EXAMPLE of the imaging lens according to the present invention;

FIG. 29 shows graphs for describing the spherical aberration, astigmatism, and distortion of the imaging lens shown in FIG. 28;

FIG. 30 is a schematic diagram for showing a FIFTEENTH EXAMPLE of the imaging lens according to the present invention;

FIG. 31 shows graphs for describing the spherical aberration, astigmatism, and distortion of the imaging lens shown in FIG. 30;

FIG. 32 is a schematic diagram for showing a SIXTEENTH EXAMPLE of the imaging lens according to the present invention;

FIG. 33 shows graphs for describing the spherical aberration, astigmatism, and distortion of the imaging lens shown in FIG. 32;

FIG. 34 is a schematic diagram for showing a SEVENTEENTH EXAMPLE of the imaging lens according to the present invention; and

FIG. 35 shows graphs for describing the spherical aberration, astigmatism, and distortion of the imaging lens shown in FIG. 34.

### DETAILED DESCRIPTION OF THE PREFERRED EMBODIMENT

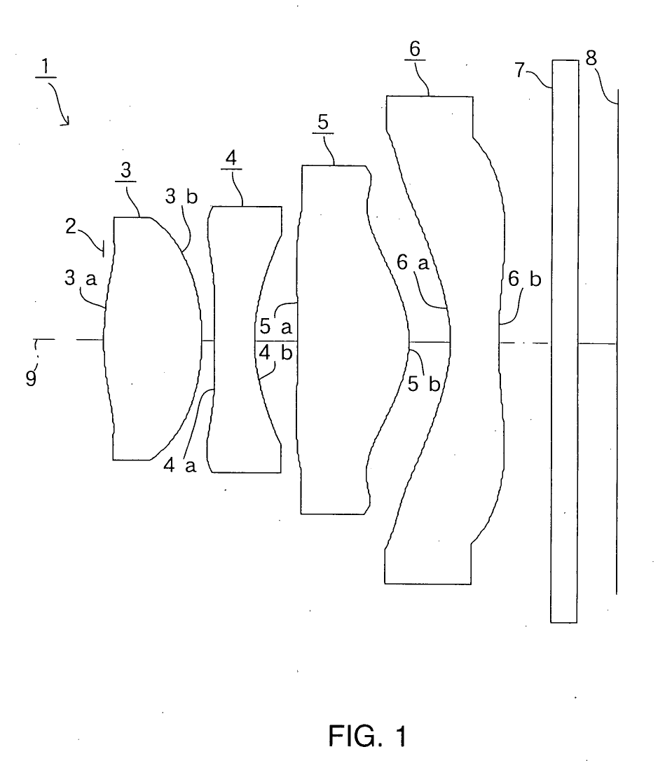

An embodiment of the imaging lens and the imaging device including the imaging lens according to the present invention will be described hereinafter with reference to FIG. 1.

As shown in FIG. 1, an imaging lens 1 according to the embodiment comprises, in order from the object side toward the image surface side, a diaphragm 2, a first lens 3 that is a biconvex lens having a positive power, a second lens 4 having a negative power, a third lens 5 having a positive power, and a fourth lens 6 that is a biconcave lens. Each lens 3, lens 4, lens 5, and lens 6 is formed using an injection-molding method using resin material, such as cycloolefinic copolymer, cycloolefinic polymer, and polycarbonate. Alternatively, the lenses are formed using silicon resin.

Hereafter, respective lens surfaces of the lens 3, the lens 4, the lens 5, and the lens 6 on the object side are referred to as a first face 3a, a first face 4a, a first face 5a, and a first face 6a, as required. Respective lens surfaces of the lens 3, the lens 4, the lens 5, and the lens 6 on the image surface side are referred to as a second face 3b, a second face 4b, a second face 5b, and a second face 6b, as required.

On the second face 6b of the fourth lens 6, there are respectively disposed various filters 7, such as a cover glass, an infrared (IR) cut filter, and a lowpass filter, and an image-taking surface 8 that is a light-receiving surface of an image sensor element, such as a CCD or a CMOS.

The imaging device according to the embodiment is composed of the imaging lens 1, the filters 7, an image sensor element, a power supply and a circuit (not shown) driving the image sensor element, and a holder (not shown) housing the imaging lens 1. The filters 7 can be omitted as required.

When the number of lenses is five or more, the overall length of the lens system becomes too long, making the lens system unsuitable for achieving size and weight reduction. The exit pupil position becomes closer to the image surface, the closer the position of the diaphragm is to the image surface. Therefore, telecentricity becomes difficult to maintain.

Therefore, according to the embodiment, the four-lens structure lens system is used. As a result, size and weight reduction can be achieved. Telecentricity can be maintained with certainty by the diaphragm being disposed on the object side of the lens closest to the object side, namely the first lens 3.

As described above, when the first lens 3 is a meniscus lens whose convex surface faces the object side, power is difficult to gain. The lens system is unsuitable for achieving side and weight reduction. When the diaphragm is disposed on the object side of the first lens 3, the incidence angle of light incident on each lens surface over a wide field angle increases. Therefore, aberration increases.

On the other hand, when the first lens 3 is a meniscus lens whose concave surface faces the object side, the occurrence of aberration can be controlled by the diaphragm being disposed on the object side of the first lens. However, power becomes difficult to gain, and the lens system becomes unsuitable for size and weight reduction.

Therefore, according to the embodiment, the first lens 3 is a biconvex lens. When the first lens 3 is coupled with the diaphragm 2, power can be gained with certainty and a configuration further suitable for achieving size and weight reduction can be realized. The aberration can be effectively controlled.

According to the embodiment, the second lens 4 has a negative power in a position near the diaphragm 2. Therefore, field curvature can be controlled without deterioration of off-axis aberration. The advantageous effect of controlling aberration can be further enhanced if the second lens 4 is an aspherical lens having a negative power that increases from the center towards the periphery. Chromatic aberration can be favorably corrected if a high-dispersion material allowing wide dispersal is used as the material for the second lens 4.

According to the embodiment, the third lens 5 has a positive power. Therefore, the required back focus distance can be effectively secured and telecentricity can be maintained with more certainty. If the center radius curvature of the second face 5b of the third lens 5 is reduced, the aberration can be more effectively controlled.

As described above, when the first face 6a of the fourth lens 6 is convex, the incidence angle of the off-axis light incident on the first face 6a of the fourth lens 6 increases, regardless of the negative power of the fourth lens 6 being weak. Therefore, the astigmatism increases. The corrective effect on the aberration by the first lens 3, the second lens 4, and the third lens 5 cannot be effectively used. Furthermore, the outer diameter of the lens increases, making size and weight reduction difficult.

Therefore, according to the embodiment, the fourth lens 6 is a biconcave lens. As a result, a well-balanced correction of astigmatism, field curvature, and distortion can be achieved. The outer diameter (effective diameter) of the lens can be reduced, and further size and weight reduction can be achieved. The third lens 5 can be given a comparatively strong positive power. A configuration that is more suitable for securing the required back focus distance and maintaining telecentricity can be realized.

If the second face 6b of the fourth lens 6 becomes convex from the center towards the periphery, a more well-balanced correction of field curvature and distortion can be achieved. Telecentricity can be maintained with more certainty.

In addition to such a configuration, according to the embodiment, a condition expressed by the following expression (1) is satisfied:

0.7≦FL/f₁≦3.0 (1)

where,

fl: focal distance of the entire lens system

f₁: focal distance of the first lens

where, FL in the expression (1) is the focal distance of the entire lens system (the same applies hereafter). f₁ in the expression (1) is the focal distance of the first lens 3 (the same applies hereafter).

When the value of FL/f₁ is smaller than the value (0.7) in the expression (1), power becomes difficult to gain. Size and weight reduction becomes difficult.

At the same time, when the value of FL/f₁ is greater than the value (3.0) in the expression (1), aberration correction becomes difficult. The required back focus distance becomes difficult to secure. Furthermore, telecentricity deteriorates.

Therefore, according to the embodiment, by the value of FL/f₁ being set to satisfy the expression (1), further size and weight reduction can be achieved. Aberration can be more appropriately corrected, the required back focus distance can be secured with more certainty, and telecentricity can be further improved.

The relationship between FL and f₁ is more preferably 1.0≦FL/f₁≦2.7.

In addition to the above-described configuration, according to the embodiment, a condition expressed by a following expression (2) is satisfied:

0.3≦FL/|f₂|≦2.8 (2)

where, |f₂| in the expression (2) is the absolute value of the focal distance (namely f₂) of the second lens 4 (the same applies hereafter).

When the value of FL/|f₂| is smaller than the value (0.3) in the expression (2), the field curvature and the distortion become difficult to correct. The required back focus distance becomes difficult to secure. As described above, when the material of the second lens 4 is a high-dispersion material, the corrective effect on chromatic aberration (color removing effect) decreases.

At the same time, when the value of FL/|f₂| is greater than the value (2.8) in the expression (2), the required back focus distance becomes difficult to secure. Telecentricity deteriorates.

Therefore, according to the embodiment, by the value of FL/|f₂| being set to satisfy the expression (2), the field curvature and the distortion can be more effectively controlled. Telecentricity can be maintained with more certainty, and the required back focus distance can be secured with more certainty.

The relationship between FL and |f₂| is more preferably 0.7≦FL/|f₂|≦2.3.

In addition to the above-described configuration, according to the embodiment, a condition expressed by a following expression (3) is satisfied:

1.3≦FL/|f₄|≦2.5 (3)

where, |f₄| in the expression (3) is the absolute value of the focal distance (namely f₄) of the fourth lens 6 (the same applies hereafter).

When the value of FL/|f₄| is smaller than the value (1.3) in the expression (3), the field curvature and the distortion become difficult to correct.

At the same time, when the value of FL/|f₄| is greater than the value (2.5) in the expression (3), the required back focus distance becomes difficult to secure. Telecentricity deteriorates.

Therefore, according to the embodiment, by the value of FL/|f₄| being set to satisfy the expression (3), the field curvature and the distortion can be more effectively controlled. The required back focus distance can be secured with more certainty, and telecentricity can be maintained with more certainty.

The relationship between FL and |f₄| is more preferably 1.65≦FL/|f₄|≦2.30.

In addition to the above-described configuration, according to the embodiment, a condition expressed by a following expression (4) is satisfied:

0.3≦(r₇+r₈)/(−r₇+r₈)≦1.2 (4)

where, r₇ in the expression (4) is the center radius curvature of the first face 6a of the fourth lens 6 (the same applies hereafter). r₈ in the expression (4) is the center radius curvature of the second face 6b of the fourth lens 6 (the same applies hereafter).

When the value of (r₇+r₈)/(−r₇+r₈) is smaller than the value (0.3) in the expression (4), telecentricity and distortion deteriorates. The incidence angle of the off-axis light incident on the lens surface increases, and the astigmatism increases.

At the same time, when the value of (r₇+r₈)/(−r₇+r₈) is greater than the value (1.2) in the expression (4), the angle of the periphery of the first face 6a of the fourth lens 6 becomes too sharp. The center of the second face 6b of the fourth lens 6 becomes difficult to make aspheric. Therefore, a well-balanced correction of the distortion, field curvature, and the astigmatism becomes difficult.

Therefore, according to the embodiment, by the value of (r₇+r₈)/(−r₇+r₈) being set to satisfy the expression (4), telecentricity can be further maintained. A well-balanced control of distortion, astigmatism, and field curvature can be achieved.

The value of (r₇+r₈)/(−r₇+r₈) is more preferably 0.28≦(r₇+r₈)/(−r₇+r₈)≦0.90.

### EXAMPLES

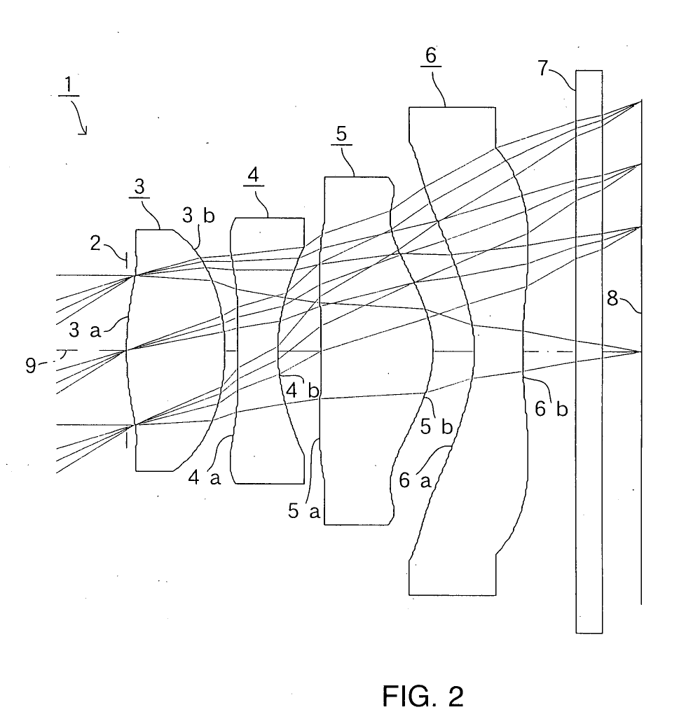

Next, EXAMPLES of the present invention will be described with reference to FIG. 2 to FIG. 35.

In the EXAMPLES, Fno denotes F number, ω denotes half of the angle-of-view, and r denotes the radius curvature of an optical surface (center radius curvature of an aspherical surface). Further, d denotes a distance on an optical axis 9 to the next optical surface, nd denotes the index of refraction of each optical system when the d line (yellow) is irradiated, and νd denotes the Abbe number of each optical system also when the d line is irradiated.

k, A, B, C, D, and E denote each coefficient in a following expression (5). Specifically, the shape of the aspherical surface of the lens is expressed by the following expression provided that the direction of the optical axis 9 is taken as the Z axis, the direction orthogonal to the optical axis 8 (height direction) as the X axis, the traveling direction of light is positive, k is the constant of cone, A, B, C, D, and E are the aspherical coefficients, and r is the center radius curvature.

Z(X)=r⁻¹X²/[1+{1−(k+1)r⁻²X²}^{1/2}]+AX⁴+BX⁶+CX⁸+DX¹⁰+EX¹² (5)

In the following EXAMPLES, reference code E used for a numerical value denoting the constant of cone and the aspherical coefficient indicates that the numerical value following E is an exponent having 10 as the base and that the numerical value before E is multiplied by the numerical value denoted by the exponent having 10 as the base. For example, −2.61E+1 denotes −2.61×10.

### First Example

FIG. 2 shows a FIRST EXAMPLE of the present invention. In the example, a cover glass serving as the filter 7 is disposed between the second face 6b of the fourth lens 6 and the image-taking surface 8. The diaphragm 2 is positioned in the optical axis 9 (Z axis) direction. The position corresponds with a surface peak of the first face 3a of the first lens 3. the shown in FIG. 2 is the same imaging lens 1 as that shown in FIG. 1. Therefore, the diaphragm 2 and the first face 3a of the first lens 3 are given the same face number in the lens data, herebelow.

The imaging lens 1 of the FIRST EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.989 | 1.13 | 1.5310 | 56.0 |
| (Diaphragm) | | | | |
| 2(Second Face of First Lens) | −2.449 | 0.15 | | |
| 3(First Face of Second Lens) | 21.295 | 0.45 | 1.5850 | 30.0 |
| 4(Second Face of Second Lens) | 1.763 | 0.50 | | |
| 5(First Face of Third Lens) | −10.553 | 1.27 | 1.5310 | 56.0 |
| 6(Second Face of Third Lens) | −1.162 | 0.48 | | |
| 7(First Face of Fourth Lens) | −1.533 | 0.55 | 1.5310 | 56.0 |
| 8(Second Face of Fourth Lens) | 5.238 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face | | | | | | |
|---|---|---|---|---|---|---|
| Number | k | A | B | C | D | E |
| 1 | −2.61E+1 | 8.82E−2 | −1.27E−1 | 8.34E−2 | −4.18E−2 | 0.00 |
| 2 | 0.00 | −4.91E−2 | 2.28E−2 | −1.90E−2 | 2.14E−3 | 0.00 |
| 3 | 0.00 | −1.49E−1 | 6.84E−2 | −3.97E−3 | 1.55E−4 | 0.00 |
| 4 | −5.97E−1 | −1.05E−1 | 4.75E−2 | −1.31E−2 | 4.15E−3 | 0.00 |
| 5 | 0.00 | 1.83E−2 | 2.96E−2 | −2.04E−2 | 4.40E−3 | 0.00 |
| 6 | −8.31E−1 | 1.37E−1 | −4.65E−2 | 2.42E−2 | −3.91E−3 | 0.00 |
| 7 | −4.44 | 4.91E−2 | −4.61E−2 | 1.76E−2 | −2.83E−3 | 1.62E−4 |
| 8 | 0.00 | −4.26E−2 | 5.87E−3 | −1.57E−3 | 2.86E−4 | −2.27E−5 |

Under such conditions, FL/f₁=−1.709 was achieved, thereby satisfying the expression (1). FL/|f₂|=1.414 was achieved, thereby satisfying the expression (2). FL/|f₄|=2.150 was achieved, thereby satisfying the expression (3). (r₇+r₈)/(−r₇+r₈)=0.547 was achieved, thereby satisfying the expression (4).

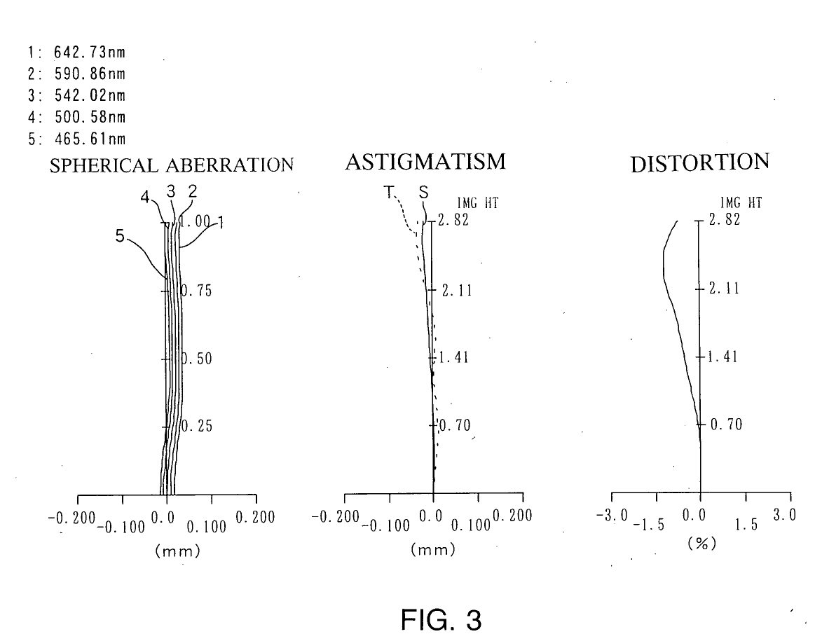

FIG. 3 shows the spherical aberration, the astigmatism and the distortion in the imaging lens 1 of the FIRST EXAMPLE.

According to the result, each of the spherical aberration, the astigmatism, and the distortion was almost satisfied. It can be seen from the result that a sufficiently excellent optical property can be obtained.

### Second Example

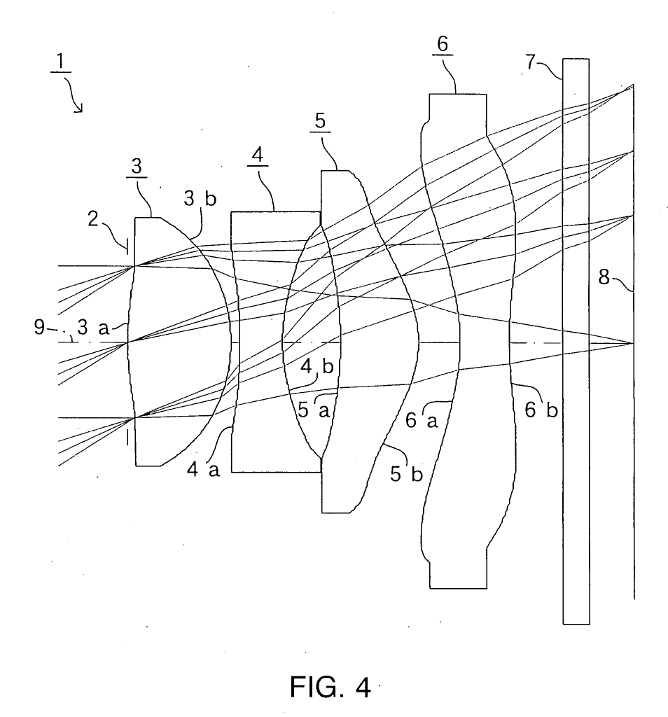

FIG. 4 shows a SECOND EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the SECOND EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.017 | 1.16 | 1.5310 | 56.0 |
| (Diaphragm) | | | | |
| 2(Second Face of First Lens) | −1.618 | 0.10 | | |
| 3(First Face of Second Lens) | −8.341 | 0.48 | 1.5850 | 30.0 |
| 4(Second Face of Second Lens) | 1.837 | 0.66 | | |
| 5(First Face of Third Lens) | −3.892 | 0.88 | 1.5310 | 56.0 |
| 6(Second Face of Third Lens) | −1.137 | 0.47 | | |
| 7(First Face of Fourth Lens) | −1.978 | 0.55 | 1.5310 | 56.0 |
| 8(Second Face of Fourth Lens) | 4.346 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face | | | | | | |
|---|---|---|---|---|---|---|
| Number | k | A | B | C | D | E |
| 1 | −3.21E+1 | 8.54E−2 | −1.44E−1 | 6.83E−2 | −4.32E−2 | 0.00 |
| 2 | 0.00 | 2.19E−2 | −1.49E−2 | −4.80E−3 | 1.15E−3 | 0.00 |
| 3 | 0.00 | −9.53E−2 | 7.10E−2 | −9.40E−3 | 4.43E−3 | 0.00 |
| 4 | −5.24E−1 | −1.11E−1 | 7.67E−2 | −3.32E−2 | 1.25E−2 | 0.00 |
| 5 | 0.00 | 6.44E−3 | 2.26E−2 | −1.95E−2 | 1.90E−3 | 0.00 |
| 6 | −8.70E−1 | 1.37E−1 | −4.54E−2 | 1.98E−2 | −3.39E−3 | 0.00 |
| 7 | −7.69 | 4.61E−2 | −4.49E−2 | 1.77E−2 | −3.01E−3 | 1.88E−4 |
| 8 | 0.00 | −5.55E−2 | 9.15E−3 | −1.95E−3 | 2.72E−4 | −1.58E−5 |

Under such conditions, FL/f₁=2.149 was achieved, thereby satisfying the expression (1). FL/|f₂|=1.854 was achieved, thereby satisfying the expression (2). FL/|f₄|=1.880 was achieved, thereby satisfying the expression (3). (r₇+r₈)/(−r₇+r₈)=0.375 was achieved, thereby satisfying the expression (4).

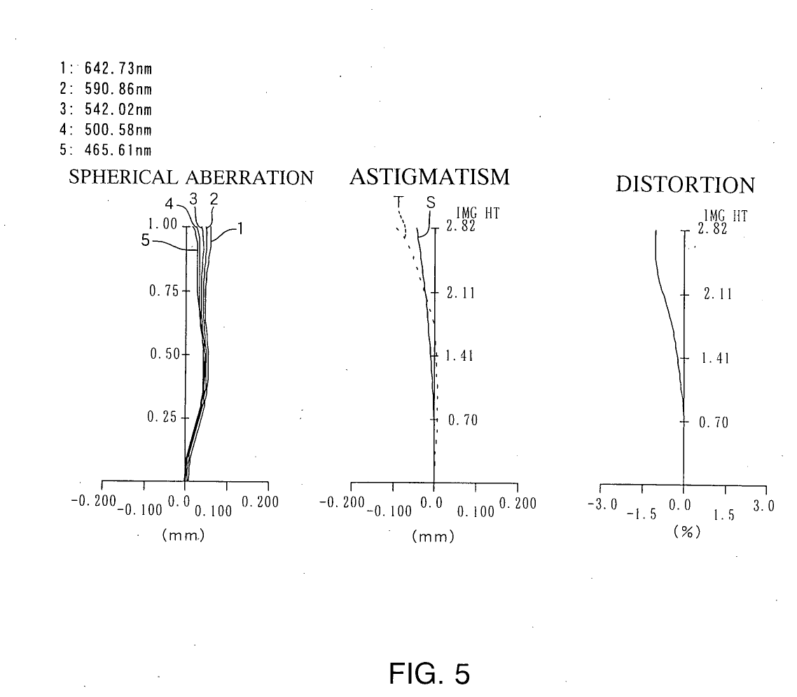

FIG. 5 shows the spherical aberration, the astigmatism and the distortion in the imaging lens 1 of the SECOND EXAMPLE.

According to the result, each of the spherical aberration, the astigmatism, and the distortion was almost satisfied. It can be seen from the result that a sufficiently excellent optical property can be obtained.

### Third Example

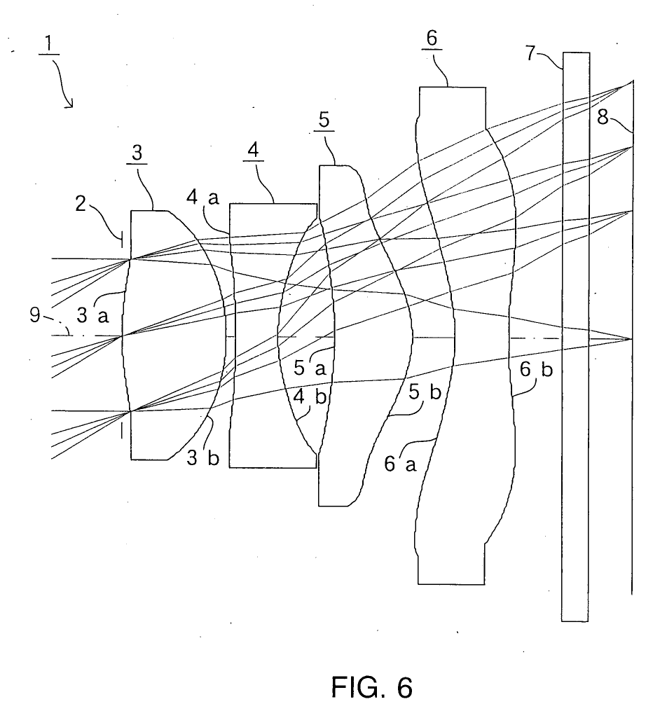

FIG. 6 shows a THIRD EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the THIRD EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.017 | 1.18 | 1.5310 | 56.0 |
| (Diaphragm) | | | | |
| 2(Second Face of First Lens) | −1.900 | 0.10 | | |
| 3(First Face of Second Lens) | −38.220 | 0.48 | 1.5850 | 30.0 |
| 4(Second Face of Second Lens) | 1.776 | 0.64 | | |
| 5(First Face of Third Lens) | −4.086 | 0.88 | 1.5310 | 56.0 |
| 6(Second Face of Third Lens) | −1.147 | 0.48 | | |
| 7(First Face of Fourth Lens) | −1.990 | 0.60 | 1.5310 | 56.0 |
| 8(Second Face of Fourth Lens) | 4.493 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −3.02E+1 | 8.97E−2 | −1.37E−1 | 7.32E−2 | −3.44E−2 | 0.00 |
| 2 | 0.00 | −9.07E−3 | 5.78E−3 | −1.09E−2 | 1.50E−3 | 0.00 |
| 3 | 0.00 | −1.12E−1 | 7.35E−2 | −6.38E−3 | 5.31E−4 | 0.00 |
| 4 | −5.24E−1 | −1.07E−1 | 6.16E−2 | −2.25E−2 | 8.24E−3 | 0.00 |
| 5 | 0.00 | 1.18E−2 | 2.81E−2 | −2.17E−2 | 3.00E−3 | 0.00 |
| 6 | −8.55E−1 | 1.36E−1 | −4.40E−2 | 2.19E−2 | −3.97E−3 | 0.00 |
| 7 | −7.61 | 4.71E−2 | −4.54E−2 | 1.78E−2 | −2.98E−3 | 1.83E−4 |
| 8 | 0.00 | −5.09E−2 | 7.94E−3 | −1.82E−3 | 2.76E−4 | −1.75E−5 |

Under such conditions, FL/f₁=1.950 was achieved, thereby satisfying the expression (1). FL/|f₂|=1.623 was achieved, thereby satisfying the expression (2). FL/|f₄|=1.855 was achieved, thereby satisfying the expression (3). (r₇+r₈)/(−r₇+r₈)=0.386 was achieved, thereby satisfying the expression (4).

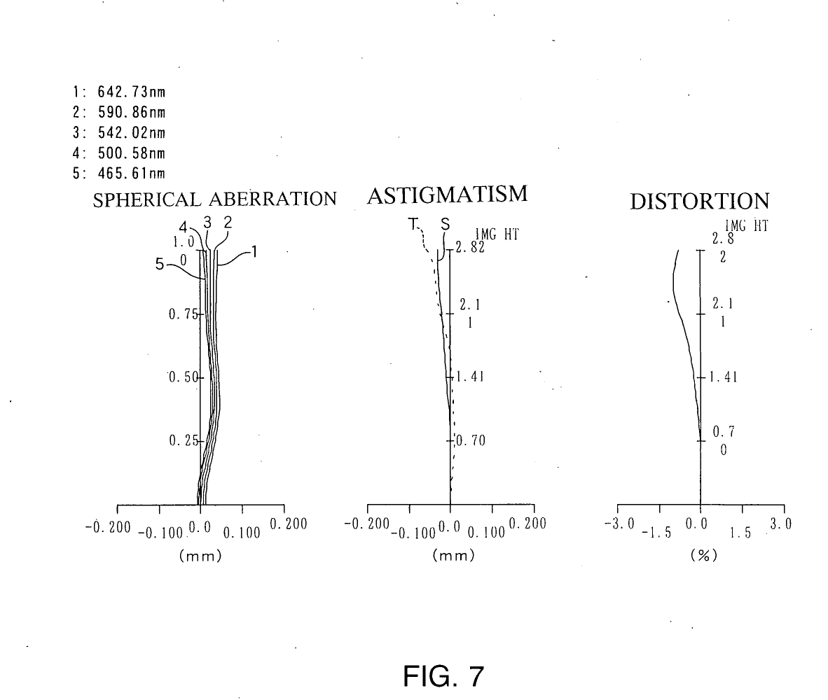

FIG. 7 shows the spherical aberration, the astigmatism and the distortion in the imaging lens 1 of the THIRD EXAMPLE.

According to the result, each of the spherical aberration, the astigmatism, and the distortion was almost satisfied. It can be seen from the result that a sufficiently excellent optical property can be obtained.

### Fourth Example

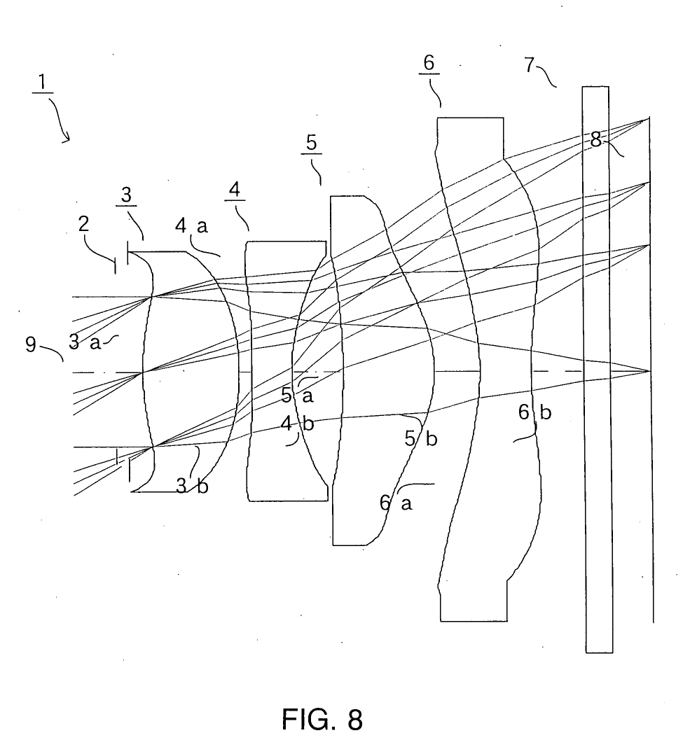

FIG. 8 shows a FOURTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the FOURTH EXAMPLE was set under the following conditions:

Lens Data
FL = 4.65 mm, Fno = 2.8, ω = 31 °

| Face Number | r | d | nd | νd |
|---|---|---|---|---|
| (Object Point) | | 8 | | |
| 1(First Face of First Lens) | 2.760 | 1.11 | 1.5310 | 56.0 |
| (Diaphragm) | | | | |
| 2(Second Face of First Lens) | −2.481 | 0.15 | | |
| 3(First Face of Second Lens) | 94.876 | 0.45 | 1.5850 | 30.0 |
| 4(Second Face of Second Lens) | 1.849 | 0.59 | | |
| 5(First Face of Third Lens) | −6.326 | 1.04 | 1.5310 | 56.0 |
| 6(Second Face of Third Lens) | −1.321 | 0.52 | | |
| 7(First Face of Fourth Lens) | −2.408 | 0.59 | 1.5310 | 56.0 |
| 8(Second Face of Fourth Lens) | 4.897 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.24E−1 | 9.64E−2 | −1.32E−1 | 7.96E−2 | −3.90E−2 | 0.00 |
| 2 | 0.00 | −4.20E−2 | 6.99E−3 | −5.11E−3 | −3.96E−3 | 0.00 |
| 3 | 0.00 | −1.25E−1 | 7.17E−2 | −9.45E−3 | 5.08E−4 | 0.00 |
| 4 | −3.55E−1 | −9.80E−2 | 5.48E−2 | −1.80E−2 | 5.39E−3 | 0.00 |
| 5 | 0.00 | 4.09E−3 | 1.04E−2 | −7.63E−3 | −1.89E−4 | 0.00 |
| 6 | −6.25E−1 | 1.18E−1 | −3.86E−2 | 1.84E−2 | −2.77E−3 | 0.00 |
| 7 | −9.83 | 4.88E−2 | −4.74E−2 | 1.74E−2 | −2.75E−3 | 1.59E−4 |
| 8 | 0.00 | −2.80E−2 | 3.65E−5 | −8.71E−4 | 2.72E−4 | −2.23E−5 |

Under such conditions, FL/f₁=1.758 was achieved, thereby satisfying the expression (1). FL/|f₂|=1.451 was achieved, thereby satisfying the expression (2). FL/|f₄|=1.579 was achieved, thereby satisfying the expression (3). (r₇+r₈)/(−r₇+r₈)=0.341 was achieved, thereby satisfying the expression (4).

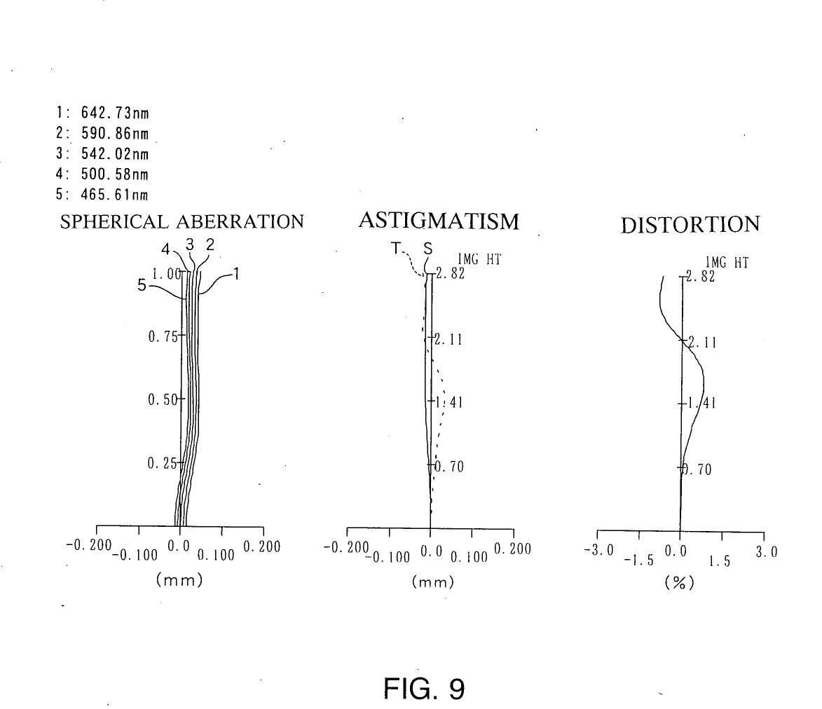

FIG. 9 shows the spherical aberration, the astigmatism and the distortion in the imaging lens 1 of the FOURTH EXAMPLE.

According to the result, each of the spherical aberration, the astigmatism, and the distortion was almost satisfied. It can be seen from the result that a sufficiently excellent optical property can be obtained.

### Fifth Example

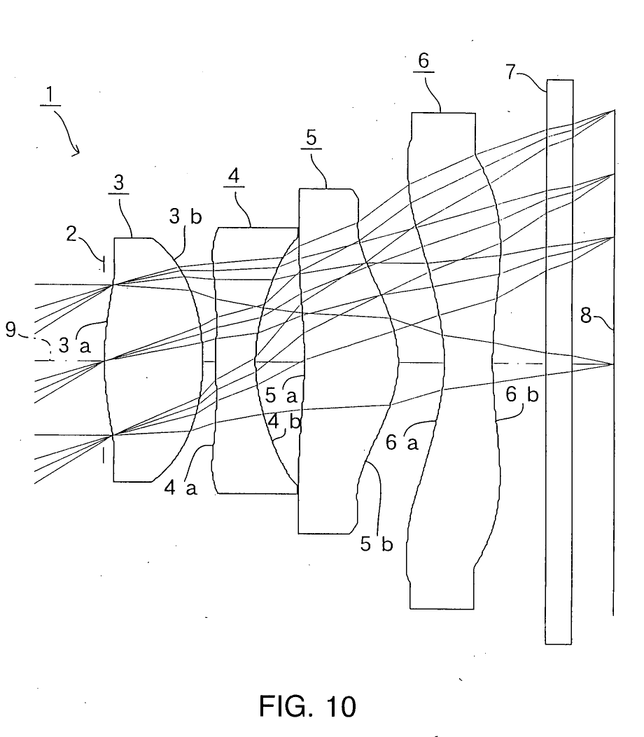

FIG. 10 shows a FIFTH example of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the FIFTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.050 | 1.12 | 1.5310 | 56.0 |
| (Diaphragm) | | | | |
| 2(Second Face of First Lens) | −2.502 | 0.15 | | |
| 3(First Face of Second Lens) | 11.195 | 0.45 | 1.5850 | 30.0 |
| 4(Second Face of Second Lens) | 1.721 | 0.56 | | |
| 5(First Face of Third Lens) | −5.700 | 1.07 | 1.5310 | 56.0 |
| 6(Second Face of Third Lens) | −1.204 | 0.52 | | |
| 7(First Face of Fourth Lens) | −1.991 | 0.55 | 1.5310 | 56.0 |
| 8(Second Face of Fourth Lens) | 4.445 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.85E+1 | 8.82E−2 | −1.30E−1 | 8.04E−2 | −3.67E−2 | 0.00 |
| 2 | 0.00 | −5.18E−2 | 2.49E−2 | −1.72E−2 | 1.35E−3 | 0.00 |
| 3 | 0.00 | −1.43E−1 | 7.23E−2 | −4.26E−3 | −8.80E−4 | 0.00 |
| 4 | −5.58E−1 | −1.04E−1 | 4.71E−2 | −1.26E−2 | 4.19E−3 | 0.00 |
| 5 | 0.00 | 2.09E−2 | 3.02E−2 | −2.24E−2 | 4.70E−3 | 0.00 |
| 6 | −8.30E−1 | 1.33E−1 | −4.51E−2 | 2.43E−2 | −4.18E−3 | 0.00 |
| 7 | −7.51 | 4.95E−2 | −4.62E−2 | 1.76E−2 | −2.83E−3 | 1.65E−4 |
| 8 | 0.00 | −4.54E−2 | 6.01E−3 | −1.56E−3 | 2.88E−4 | −2.03E−1 |

Under such conditions, FL/f₁=1.677 was achieved, thereby satisfying the expression (1). FL/|f₂|=1.325 was achieved, thereby satisfying the expression (2). FL/|f₄|=1.856 was achieved, thereby satisfying the expression (3). (r₇+r₈)/(−r₇+r₈)=0.381 was achieved, thereby satisfying the expression (4).

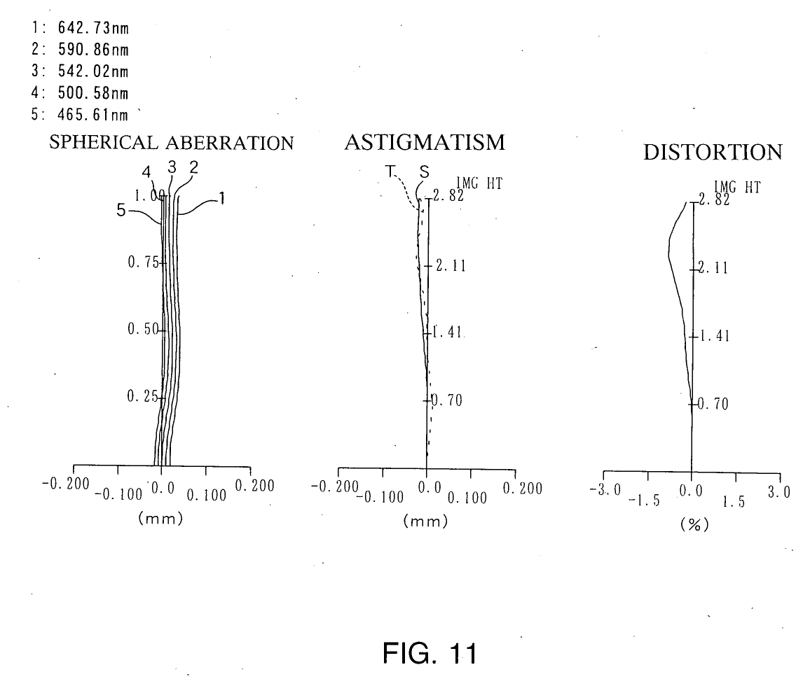

FIG. 11 shows the spherical aberration, the astigmatism and the distortion in the imaging lens 1 of the FIFTH EXAMPLE.

According to the result, each of the spherical aberration, the astigmatism, and the distortion was almost satisfied. It can be seen from the result that a sufficiently excellent optical property can be obtained.

### Sixth Example

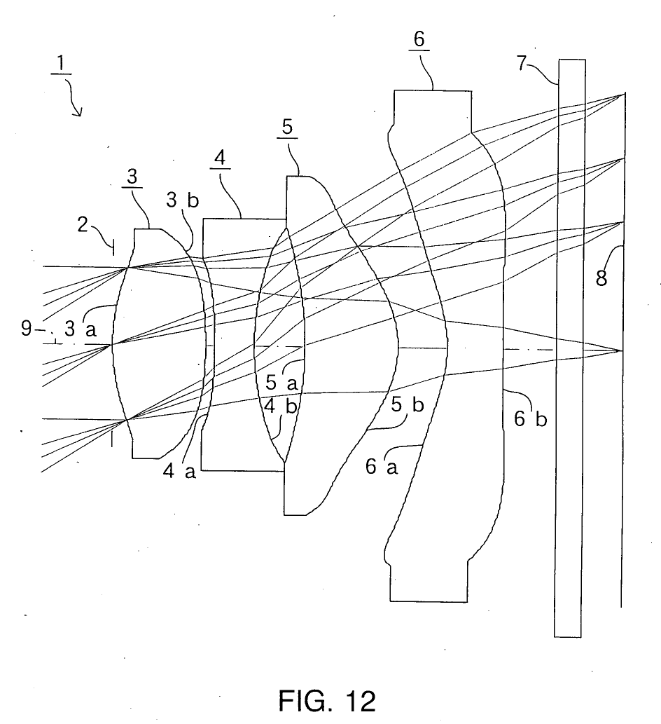

FIG. 12 shows a SIXTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the SIXTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.053 | 1.05 | 1.5310 | 56.0 |
| (Diaphragm) | | | | |
| 2(Second Face of First Lens) | −4.701 | 0.10 | | |
| 3(First Face of Second Lens) | −12.952 | 0.45 | 1.5850 | 30.0 |
| 4(Second Face of Second Lens) | 2.664 | 0.57 | | |
| 5(First Face of Third Lens) | −4.145 | 1.05 | 1.5310 | 56.0 |
| 6(Second Face of Third Lens) | −1.080 | 0.56 | | |
| 7(First Face of Fourth Lens) | −1.332 | 0.62 | 1.5310 | 56.0 |
| 8(Second Face of Fourth Lens) | 4575.452 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −1.46E+1 | 1.86E−1 | −2.08E−1 | 1.67E−1 | −8.02E−2 | 0.00 |
| 2 | 0.00 | −9.56E−2 | −1.39E−2 | 7.35E−3 | −9.64E−3 | 0.00 |
| 3 | 0.00 | −1.39E−1 | −9.15E−4 | 3.33E−3 | 1.04E−2 | 0.00 |
| 4 | −2.81E−1 | −2.82E−2 | 2.35E−2 | −1.09E−2 | 7.20E−3 | 0.00 |
| 5 | 0.00 | −5.13E−2 | 5.91E−2 | −1.72E−2 | −9.26E−4 | 0.00 |
| 6 | −7.47E−1 | 9.90E−2 | −2.91E−2 | 2.14E−2 | −3.89E−3 | 0.00 |
| 7 | −3.26 | 9.67E−2 | −5.16E−2 | 1.53E−2 | −2.53E−3 | 1.72E−4 |
| 8 | 0.00 | 2.56E−2 | −1.59E−2 | 2.98E−3 | −2.96E−4 | 9.47E−6 |

Under such conditions, FL/f₁=1.641 was achieved, thereby satisfying the expression (1). FL/|f₂|=1.254 was achieved, thereby satisfying the expression (2). FL/|f₄|=1.862 was achieved, thereby satisfying the expression (3). (r₇+r₈)/(−r₇+r₈)=0.999 was achieved, thereby satisfying the expression (4).

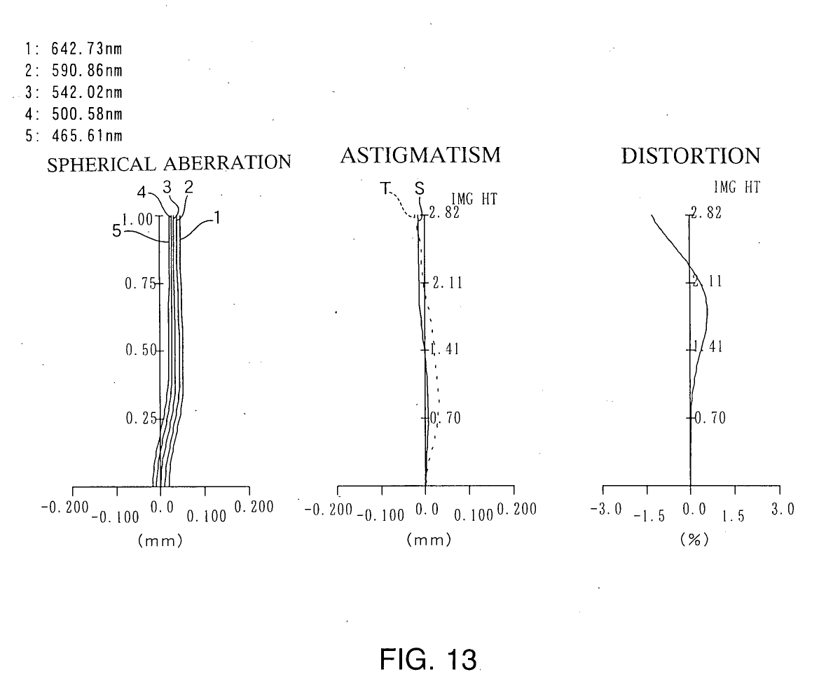

FIG. 13 shows the spherical aberration, the astigmatism and the distortion in the imaging lens 1 of the SIXTH EXAMPLE.

According to the result, each of the spherical aberration, the astigmatism, and the distortion was almost satisfied. It can be seen from the result that a sufficiently excellent optical property can be obtained.

### Seventh Example

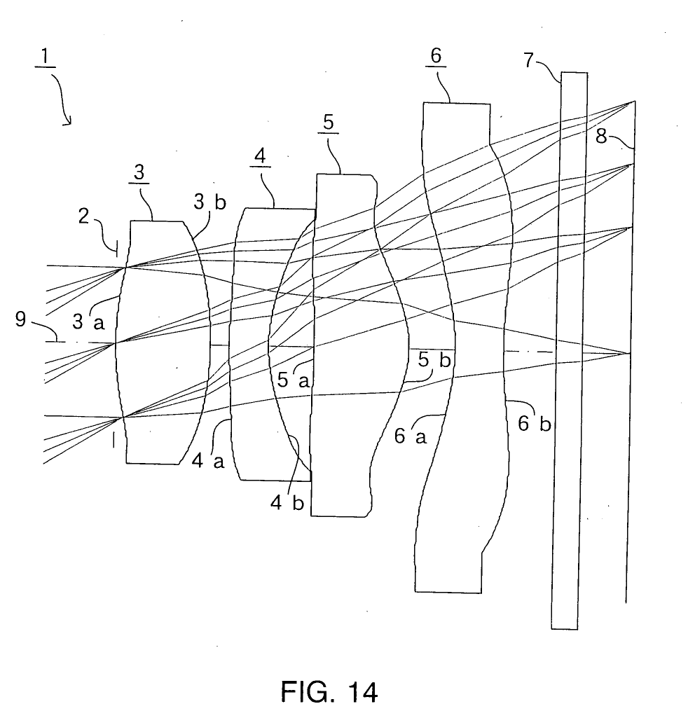

FIG. 14 shows a SEVENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the SEVENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.148 | 1.09 | 1.5310 | 56.0 |
| (Diaphragm) | | | | |
| 2(Second Face of First Lens) | −4.253 | 0.22 | | |
| 3(First Face of Second Lens) | 4.376 | 0.45 | 1.5850 | 30.0 |
| 4(Second Face of Second Lens) | 1.710 | 0.52 | | |
| 5(First Face of Third Lens) | −8.863 | 1.08 | 1.5310 | 56.0 |
| 6(Second Face of Third Lens) | −1.253 | 0.53 | | |
| 7(First Face of Fourth Lens) | −2.068 | 0.55 | 1.5310 | 56.0 |
| 8(Second Face of Fourth Lens) | 4.599 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.96E+1 | 9.36E−2 | −1.23E−1 | 8.62E−2 | −3.21E−2 | 0.00 |
| 2 | 0.00 | −5.72E−2 | 3.21E−2 | −1.33E−2 | 1.18E−3 | 0.00 |
| 3 | 0.00 | −1.40E−1 | 7.16E−2 | −4.45E−3 | −1.82E−3 | 0.00 |
| 4 | −6.11E−1 | −1.05E−1 | 4.53E−2 | −1.22E−2 | 4.05E−3 | 0.00 |
| 5 | 0.00 | 1.57E−2 | 3.01E−2 | −2.14E−2 | 4.48E−3 | 0.00 |
| 6 | −8.15E−1 | 1.31E−2 | −4.48E−2 | 2.50E−2 | −4.32E−3 | 0.00 |
| 7 | −7.81 | 4.83E−2 | −4.57E−2 | 1.79E−2 | −2.95E−3 | 1.76E−4 |
| 8 | 0.00 | −4.41E−2 | 5.93E−3 | −1.52E−3 | 2.90E−4 | −2.23E−5 |

Under such conditions, FL/f₁=1.300 was achieved, thereby satisfying the expression (1). FL/|f₂|=0.916 was achieved, thereby satisfying the expression (2). FL/|f₄|=1.788 was achieved, thereby satisfying the expression (3). (r₇+r₈)/(−r₇+r₈)=0.380 was achieved, thereby satisfying the expression (4).

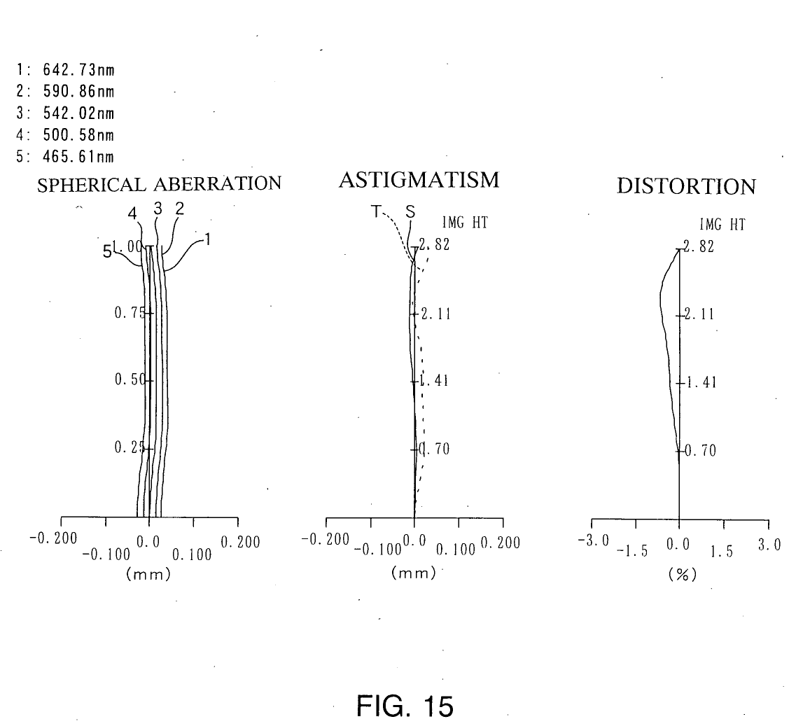

FIG. 15 shows the spherical aberration, the astigmatism and the distortion in the imaging lens 1 of the SEVENTH EXAMPLE.

According to the result, each of the spherical aberration, the astigmatism, and the distortion was almost satisfied. It can be seen from the result that a sufficiently excellent optical property can be obtained.

### Eighth Example

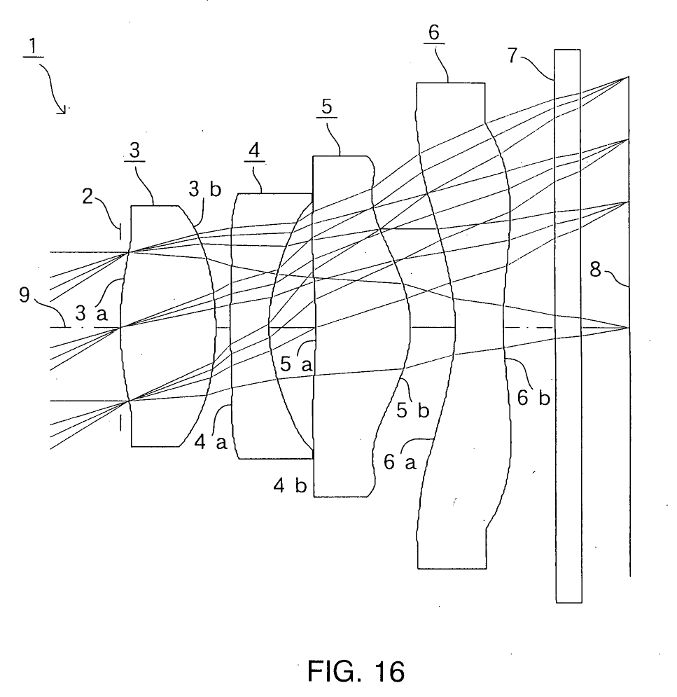

FIG. 16 shows a EIGHTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the EIGHTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.105 | 1.10 | 1.5310 | 56.0 |
| (Diaphragm) | | | | |
| 2(Second Face of First Lens) | −3.335 | 0.17 | | |
| 3(First Face of Second Lens) | 5.463 | 0.45 | 1.5850 | 30.0 |
| 4(Second Face of Second Lens) | 1.682 | 0.54 | | |
| 5(First Face of Third Lens) | −7.692 | 1.09 | 1.5310 | 56.0 |
| 6(Second Face of Third Lens) | −1.238 | 0.51 | | |
| 7(First Face of Fourth Lens) | −2.054 | 0.56 | 1.5310 | 56.0 |
| 8(Second Face of Fourth Lens) | 4.573 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.95E+1 | 9.25E−2 | −1.25E−1 | 8.42E−2 | −3.34E−2 | 0.00 |
| 2 | 0.00 | −5.60E−2 | 3.11E−2 | −1.44E−2 | 6.90E−4 | 0.00 |
| 3 | 0.00 | −1.40E−1 | 7.18E−2 | −4.31E−3 | −1.85E−3 | 0.00 |
| 4 | −6.04E−1 | −1.05E−1 | 4.55E−2 | −1.22E−2 | 4.04E−3 | 0.00 |
| 5 | 0.00 | 1.67E−2 | 3.05E−2 | −2.14E−2 | 4.46E−3 | 0.00 |
| 6 | −8.15E−1 | 1.31E−1 | −4.50E−2 | 2.49E−2 | −4.32E−3 | 0.00 |
| 7 | −7.64 | 4.84E−2 | −4.57E−2 | 1.79E−2 | −2.95E−3 | 1.75E−4 |
| 8 | 0.00 | −4.45E−2 | 5.95E−3 | −1.52E−3 | 2.90E−4 | −2.21E−5 |

Under such conditions, FL/f₁=1.450 was achieved, thereby satisfying the expression (1). FL/|f₂|=1.079 was achieved, thereby satisfying the expression (2). FL/|f₄|=1.800 was achieved, thereby satisfying the expression (3). (r₇+r₈)/(−r₇+r₈)=0.380 was achieved, thereby satisfying the expression (4).

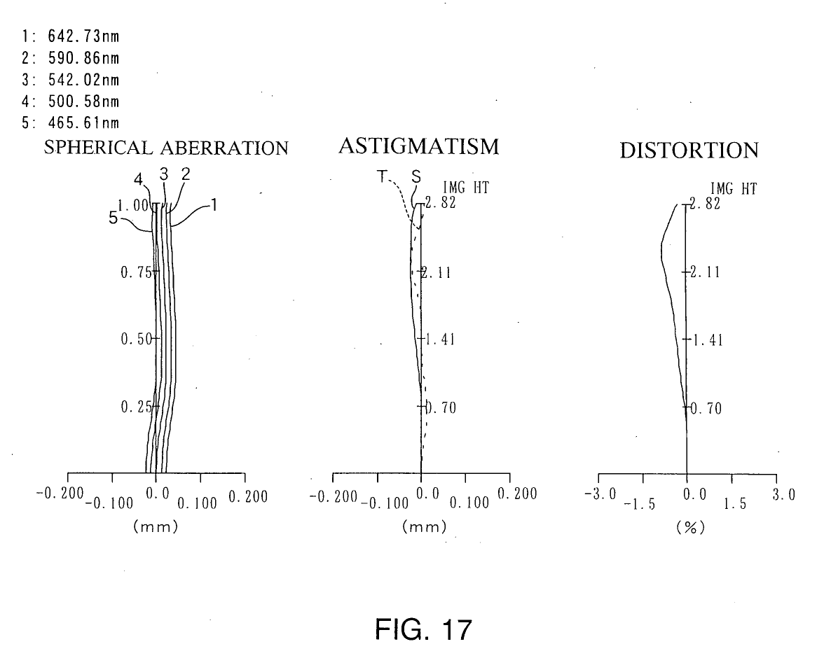

FIG. 17 shows the spherical aberration, the astigmatism and the distortion in the imaging lens 1 of the EIGHTH EXAMPLE.

According to the result, each of the spherical aberration, the astigmatism, and the distortion was almost satisfied. It can be seen from the result that a sufficiently excellent optical property can be obtained.

### Ninth Example

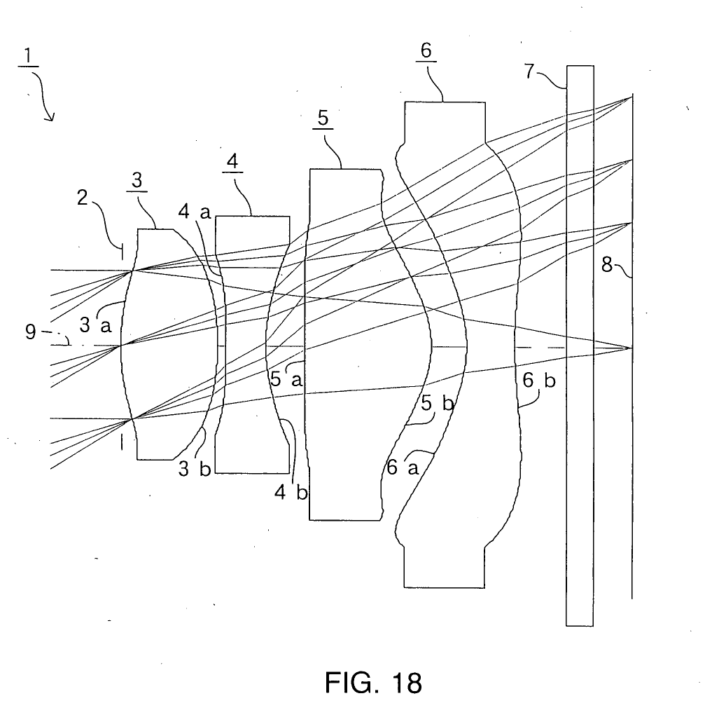

FIG. 18 shows a NINTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the NINTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.442 | 1.12 | 1.5310 | 56.0 |
| (Diaphragm) | | | | |
| 2(Second Face of First Lens) | −2.967 | 0.09 | | |
| 3(First Face of Second Lens) | −60.157 | 0.46 | 1.5850 | 30.0 |
| 4(Second Face of Second Lens) | 1.924 | 0.45 | | |
| 5(First Face of Third Lens) | −30.663 | 1.46 | 1.5310 | 56.0 |
| 6(Second Face of Third Lens) | −1.109 | 0.41 | | |
| 7(First Face of Fourth Lens) | −1.375 | 0.55 | 1.5310 | 56.0 |
| 8(Second Face of Fourth Lens) | 5.170 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −1.54E+1 | 1.13E−1 | −1.19E−1 | 7.70E−2 | −3.87E−2 | 0.00 |
| 2 | 0.00 | −6.02E−2 | 1.25E−2 | −1.01E−2 | −3.28E−3 | 0.00 |
| 3 | 0.00 | −1.57E−1 | 5.57E−2 | −1.15E−2 | 5.04E−3 | 0.00 |
| 4 | −3.52E−1 | −9.34E−2 | 4.63E−2 | −1.63E−2 | 5.13E−3 | 0.00 |
| 5 | 0.00 | 2.57E−4 | 3.56E−2 | −2.06E−2 | 4.05E−3 | 0.00 |
| 6 | −8.24E−1 | 1.52E−1 | −5.84E−2 | 2.44E−2 | −3.30E−3 | 0.00 |
| 7 | −3.98 | 5.11E−2 | −4.92E−2 | 1.72E−2 | −2.86E−3 | 2.07E−4 |
| 8 | 0.00 | −3.92E−2 | 5.80E−3 | −1.95E−3 | 3.34E−4 | −2.43E−5 |

Under such conditions, FL/f₁=1.718 was achieved, thereby satisfying the expression (1). FL/|f₂|=1.475 was achieved, thereby satisfying the expression (2). FL/|f₄|=2.350 was achieved, thereby satisfying the expression (3). (r₇+r₈)/(−r₇+r₈)=0.580 was achieved, thereby satisfying the expression (4).

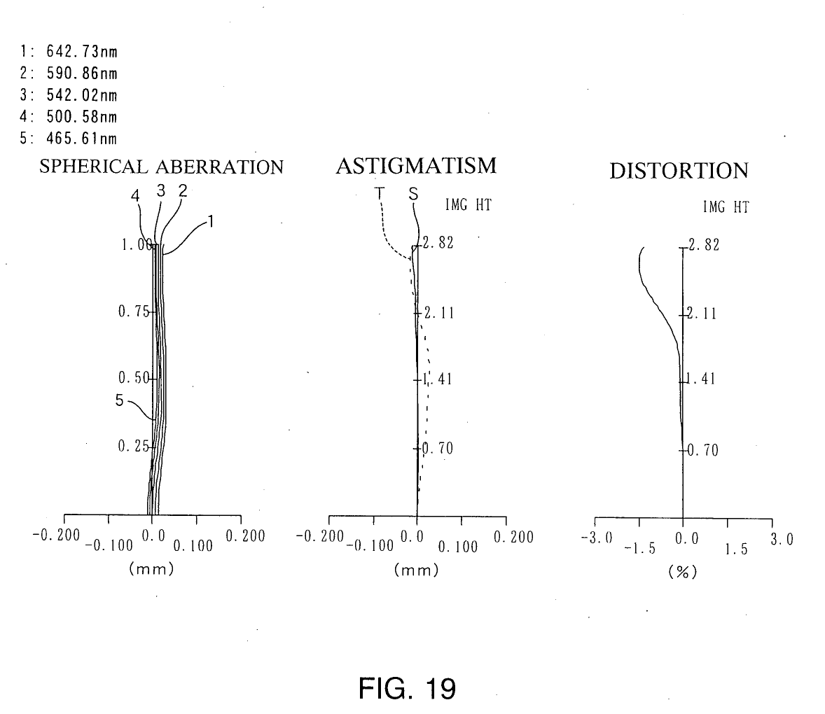

FIG. 19 shows the spherical aberration, the astigmatism and the distortion in the imaging lens 1 of the NINTH EXAMPLE.

According to the result, each of the spherical aberration, the astigmatism, and the distortion was almost satisfied. It can be seen from the result that a sufficiently excellent optical property can be obtained.

### Tenth Example

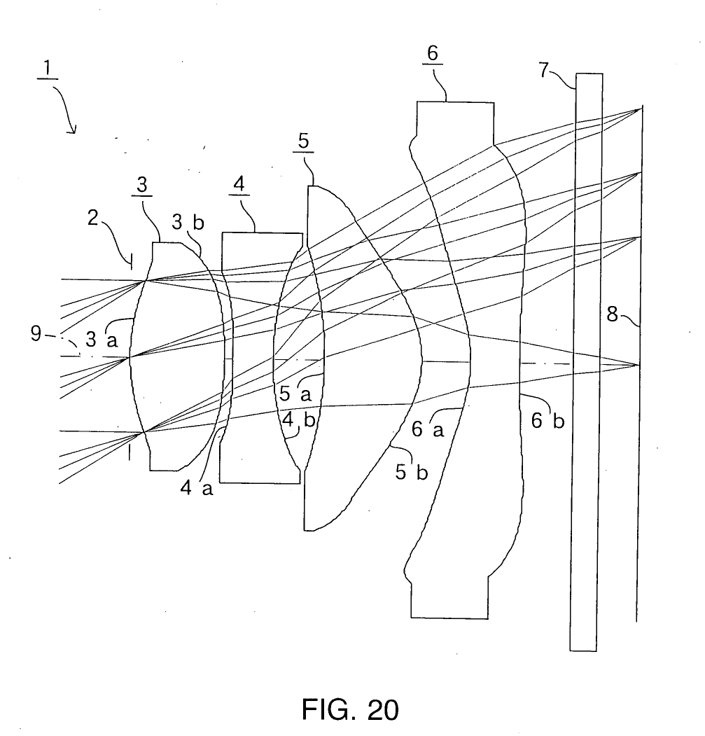

FIG. 20 shows a TENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the TENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.058 | 1.07 | 1.5310 | 56.0 |
| (Diaphragm) | | | | |
| 2(Second Face of First Lens) | −4.664 | 0.10 | | |
| 3(First Face of Second Lens) | −11.550 | 0.45 | 1.5850 | 30.0 |
| 4(Second Face of Second Lens) | 2.769 | 0.58 | | |
| 5(First Face of Third Lens) | −4.191 | 1.10 | 1.5310 | 56.0 |
| 6(Second Face of Third Lens) | −1.079 | 0.55 | | |
| 7(First Face of Fourth Lens) | −1.401 | 0.55 | 1.5310 | 56.0 |
| 8(Second Face of Fourth Lens) | 16.860 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −1.45E+1 | 1.84E−1 | −2.05E−1 | 1.64E−1 | −7.82E−2 | 0.00 |
| 2 | 0.00 | −9.85E−2 | −1.20E−2 | 7.54E−3 | −9.29E−3 | 0.00 |
| 3 | 0.00 | −1.37E−1 | 3.15E−4 | 2.81E−3 | 9.95E−3 | 0.00 |
| 4 | 1.65E−1 | −2.47E−2 | 2.26E−2 | −1.07E−2 | 6.95E−3 | 0.00 |
| 5 | 0.00 | −5.18E−2 | 5.72E−2 | −1.84E−2 | −2.93E−4 | 0.00 |
| 6 | −7.51E−1 | 1.00E−1 | −2.92E−2 | 1.84E−2 | −3.28E−3 | 0.00 |
| 7 | −3.51 | 9.43E−2 | −5.18E−2 | 1.55E−2 | −2.57E−3 | 1.73E−4 |
| 8 | 0.00 | 1.62E−2 | −1.34E−2 | 2.65E−3 | −2.81E−4 | 9.91E−6 |

Under such conditions, FL/f₁=1.640 was achieved, thereby satisfying the expression (1). FL/|f₂|=1.242 was achieved, thereby satisfying the expression (2). FL/|f₄|=1.937 was achieved, thereby satisfying the expression (3). (r₇+r₈)/(−r₇+r₈)=0.847 was achieved, thereby satisfying the expression (4).

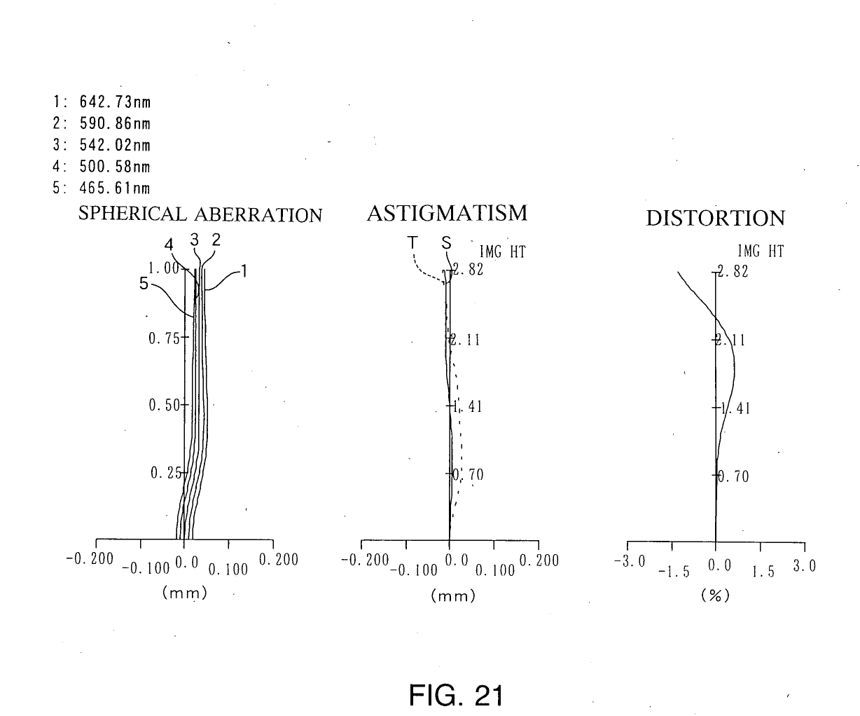

FIG. 21 shows the spherical aberration, the astigmatism and the distortion in the imaging lens 1 of the TENTH EXAMPLE.

According to the result, each of the spherical aberration, the astigmatism, and the distortion was almost satisfied. It can be seen from the result that a sufficiently excellent optical property can be obtained.

### Eleventh Example

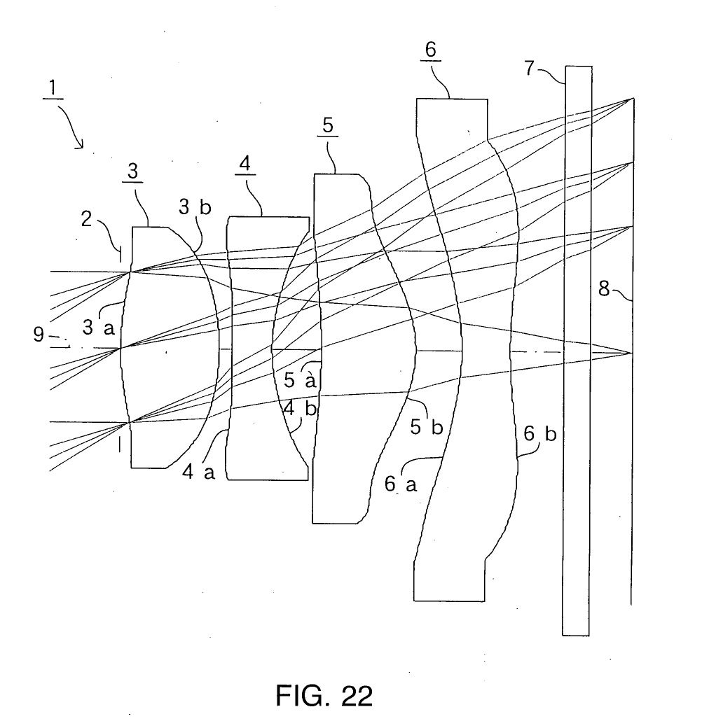

FIG. 22 shows an ELEVENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the ELEVENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.829 | 1.12 | 1.5310 | 56.0 |
| (Diaphragm) | | | | |
| 2(Second Face of First Lens) | −2.499 | 0.15 | | |
| 3(First Face of Second Lens) | 29.967 | 0.45 | 1.5850 | 30.0 |
| 4(Second Face of Second Lens) | 1.802 | 0.56 | | |
| 5(First Face of Third Lens) | −6.276 | 1.07 | 1.5310 | 56.0 |
| 6(Second Face of Third Lens) | −1.275 | 0.52 | | |
| 7(First Face of Fourth Lens) | −2.204 | 0.55 | 1.5310 | 56.0 |
| 8(Second Face of Fourth Lens) | 4.991 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.31E+1 | 9.26E−2 | −1.28E−1 | 7.80E−2 | −3.77E−2 | 0.00 |
| 2 | 0.00 | −4.50E−2 | 1.18E−2 | −8.29E−3 | −2.57E−3 | 0.00 |
| 3 | 0.00 | −1.33E−1 | 7.18E−2 | −8.69E−3 | 2.05E−4 | 0.00 |
| 4 | −4.35E−1 | −1.01E−1 | 5.23E−2 | −1.54E−2 | 4.23E−3 | 0.00 |
| 5 | 0.00 | 1.06E−2 | 1.72E−2 | −1.17E−2 | 1.59E−3 | 0.00 |
| 6 | −7.02E−1 | 1.23E−1 | −4.15E−2 | 2.12E−2 | −3.38E−3 | 0.00 |
| 7 | −8.60 | 4.86E−2 | −4.69E−2 | 1.75E−2 | −2.80E−3 | 1.63E−4 |
| 8 | 0.00 | −3.20E−2 | 1.82E−3 | −1.11E−3 | 2.89E−4 | −2.39E−5 |

Under such conditions, FL/f₁=1.732 was achieved, thereby satisfying the expression (1). FL/|f₂|=1.421 was achieved, thereby satisfying the expression (2). FL/|f₄|=1.665 was achieved, thereby satisfying the expression (3). (r₇+r₈)/(−r₇+r₈)=0.387 was achieved, thereby satisfying the expression (4).

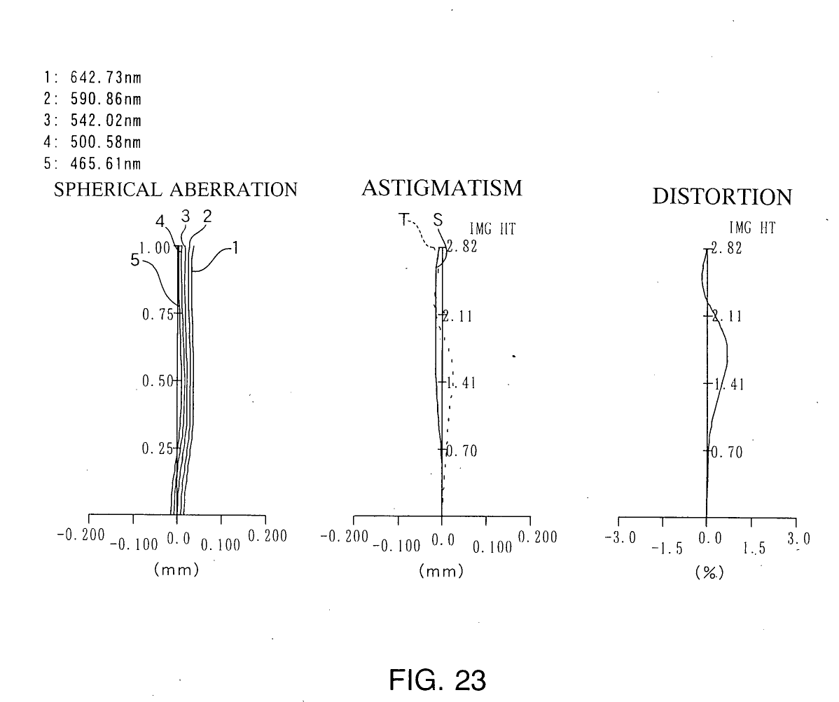

FIG. 23 shows the spherical aberration, the astigmatism and the distortion in the imaging lens 1 of the ELEVENTH EXAMPLE.

According to the result, each of the spherical aberration, the astigmatism, and the distortion was almost satisfied. It can be seen from the result that a sufficiently excellent optical property can be obtained.

### Twelfth Example

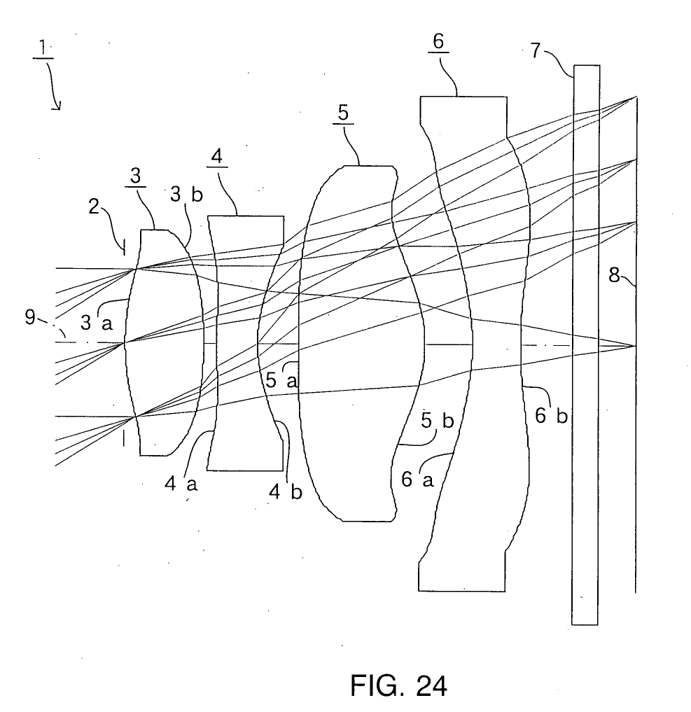

FIG. 24 shows a TWELFTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the TWELFTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.622 | 0.90 | 1.5310 | 56.0 |
| (Diaphragm) | | | | |
| 2(Second Face of First Lens) | −4.040 | 0.15 | | |
| 3(First Face of Second Lens) | 6.974 | 0.47 | 1.5850 | 30.0 |
| 4(Second Face of Second Lens) | 1.581 | 0.47 | | |
| 5(First Face of Third Lens) | 33.393 | 1.46 | 1.5310 | 56.0 |
| 6(Second Face of Third Lens) | −1.488 | 0.55 | | |
| 7(First Face of Fourth Lens) | −2.398 | 0.55 | 1.5310 | 56.0 |
| 8(Second Face of Fourth Lens) | 4.746 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −1.81E+1 | 1.09E−1 | −1.26E−1 | 8.73E−2 | −4.27E−2 | 0.00 |
| 2 | 0.00 | −4.42E−2 | 2.36E−3 | −7.23E−3 | −5.30E−3 | 0.00 |
| 3 | 0.00 | −1.47E−1 | 5.62E−2 | −1.45E−2 | 3.80E−3 | 0.00 |
| 4 | −7.19E−1 | −1.18E−1 | 5.60E−2 | −1.71E−2 | 3.80E−3 | 0.00 |
| 5 | 0.00 | 2.13E−2 | 9.10E−3 | −6.07E−3 | 1.07E−3 | 0.00 |
| 6 | −5.78E−1 | 1.14E−1 | −3.92E−2 | 1.97E−2 | −2.86E−3 | 0.00 |
| 7 | −9.30 | 4.22E−2 | −4.70E−2 | 1.79E−2 | −2.76E−3 | 1.48E−1 |
| 8 | 0.00 | −2.55E−2 | −8.56E−4 | −5.60E−4 | 2.56E−4 | −2.38E−5 |

Under such conditions, FL/f₁=1.486 was achieved, thereby satisfying the expression (1). FL/|f₂|=1.298 was achieved, thereby satisfying the expression (2). FL/|f₄|=1.598 was achieved, thereby satisfying the expression (3). (r₇+r₈)/(−r₇+r₈)=0.329 was achieved, thereby satisfying the expression (4).

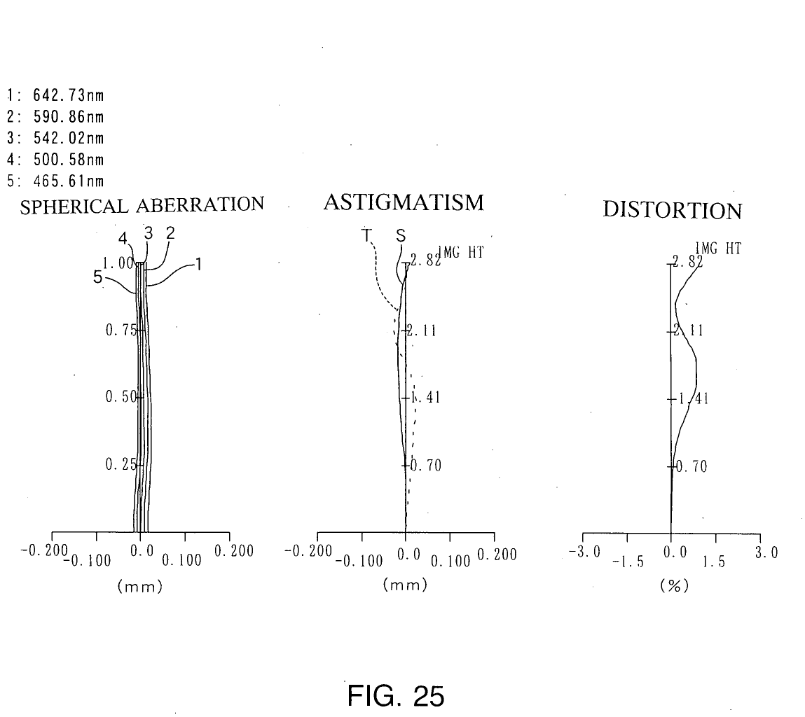

FIG. 25 shows the spherical aberration, the astigmatism and the distortion in the imaging lens 1 of the TWELFTH EXAMPLE.

According to the result, each of the spherical aberration, the astigmatism, and the distortion was almost satisfied. It can be seen from the result that a sufficiently excellent optical property can be obtained.

### Thirteenth Example

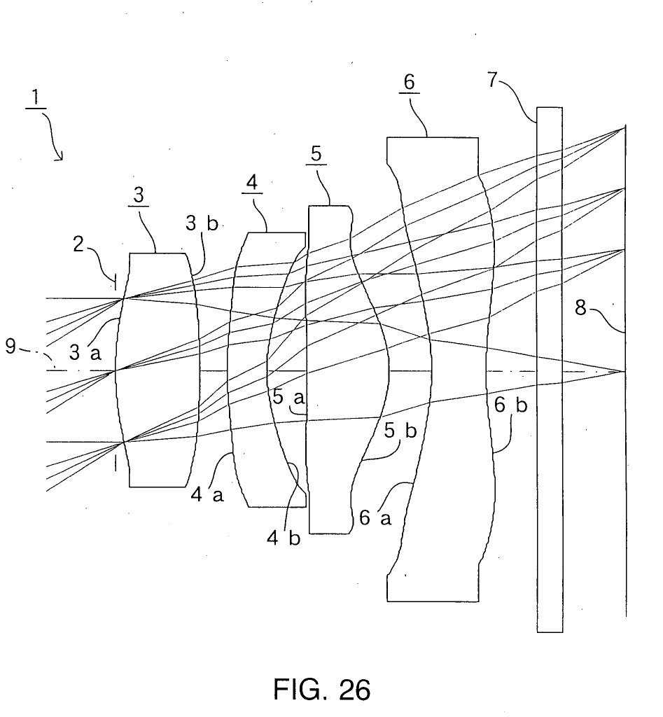

FIG. 26 shows a THIRTEENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the THIRTEENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.224 | 1.00 | 1.5310 | 56.0 |
| (Diaphragm) | | | | |
| 2(Second Face of First Lens) | −12.209 | 0.32 | | |
| 3(First Face of Second Lens) | 3.289 | 0.47 | 1.5850 | 30.0 |
| 4(Second Face of Second Lens) | 1.811 | 0.48 | | |
| 5(First Face of Third Lens) | −12.328 | 0.97 | 1.5310 | 56.0 |
| 6(Second Face of Third Lens) | −1.232 | 0.50 | | |
| 7(First Face of Fourth Lens) | −2.399 | 0.64 | 1.5310 | 56.0 |
| 8(Second Face of Fourth Lens) | 4.225 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −3.19E+1 | 9.72E−2 | −1.18E−1 | 8.99E−2 | −3.42E−2 | 0.00 |
| 2 | 0.00 | −5.84E−2 | 3.91E−2 | −1.28E−2 | 6.30E−5 | 0.00 |
| 3 | 0.00 | −1.41E−1 | 6.98E−2 | −4.42E−3 | −1.96E−3 | 0.00 |
| 4 | −6.47E−1 | −1.06E−1 | 4.46E−2 | −1.23E−2 | 3.74E−3 | 0.00 |
| 5 | 0.00 | 1.07E−2 | 3.04E−2 | −2.07E−2 | 4.48E−3 | 0.00 |
| 6 | −7.97E−1 | 1.27E−1 | −4.46E−2 | 2.51E−2 | −4.26E−3 | 0.00 |
| 7 | −1.03E+1 | 4.67E−2 | −4.57E−2 | 1.79E−2 | −2.95E−3 | 1.70E−4 |
| 8 | 0.00 | −4.38E−2 | 5.85E−3 | −1.44E−3 | 2.90E−4 | −2.36E−5 |

Under such conditions, FL/f₁=0.950 was achieved, thereby satisfying the expression (1). FL/|f₂|=0.601 was achieved, thereby satisfying the expression (2). FL/|f₄|=1.674 was achieved, thereby satisfying the expression (3). (r₇+r₈)/(−r₇+r₈)=0.276 was achieved, thereby satisfying the expression (4).

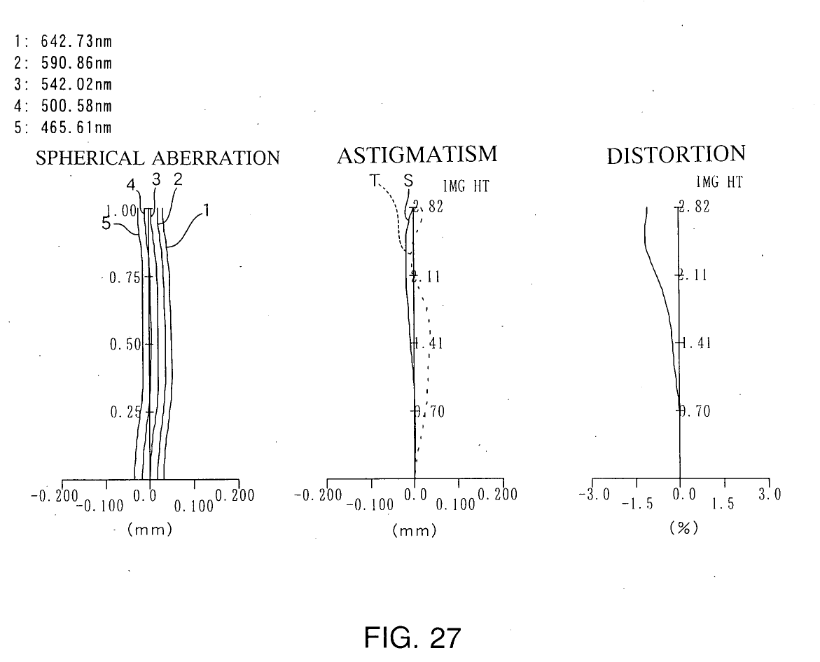

FIG. 27 shows the spherical aberration, the astigmatism and the distortion in the imaging lens 1 of the THIRTEENTH EXAMPLE.

According to the result, each of the spherical aberration, the astigmatism, and the distortion was almost satisfied. It can be seen from the result that a sufficiently excellent optical property can be obtained.

### Fourteenth Example

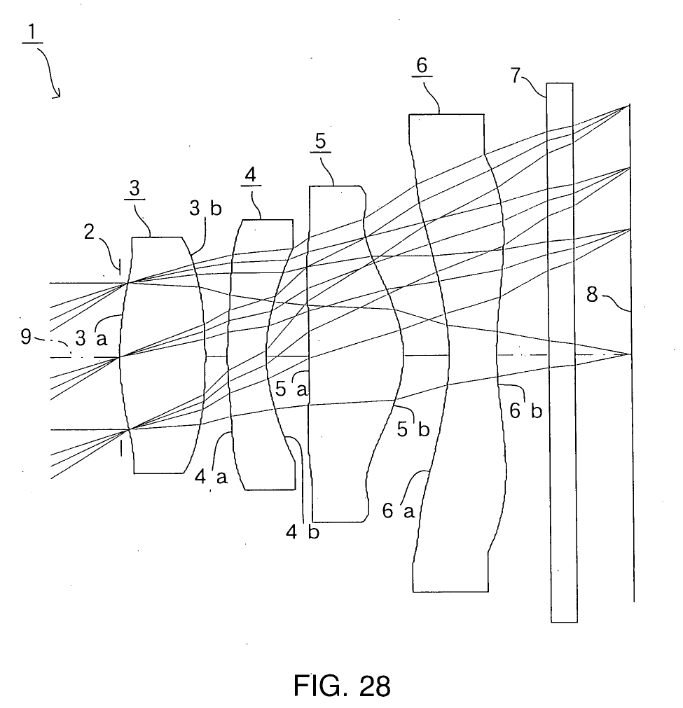

FIG. 28 shows a FOURTEENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the FOURTEENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.182 | 0.99 | 1.5310 | 56.0 |
| (Diaphragm) | | | | |
| 2(Second Face of First Lens) | −5.964 | 0.26 | | |
| 3(First Face of Second Lens) | 3.798 | 0.45 | 1.5850 | 30.0 |
| 4(Second Face of Second Lens) | 1.736 | 0.50 | | |
| 5(First Face of Third Lens) | −11.097 | 1.09 | 1.5310 | 56.0 |
| 6(Second Face of Third Lens) | −1.258 | 0.53 | | |
| 7(First Face of Fourth Lens) | −2.286 | 0.55 | 1.5310 | 56.0 |
| 8(Second Face of Fourth Lens) | 4.239 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −3.13E+1 | 9.56E−2 | −1.21E−1 | 8.73E−2 | −3.31E−2 | 0.00 |
| 2 | 0.00 | −5.89E−2 | 3.51E−2 | −1.31E−2 | 3.09E−4 | 0.00 |
| 3 | 0.00 | −1.40E−1 | 7.07E−2 | −4.56E−3 | −1.87E−3 | 0.00 |
| 4 | −6.20E−1 | −1.06E−1 | 4.49E−2 | −1.22E−2 | 3.94E−3 | 0.00 |
| 5 | 0.00 | 1.42E−2 | 3.02E−2 | −2.10E−2 | 4.56E−3 | 0.00 |
| 6 | −7.98E−1 | 1.28E−1 | −4.48E−2 | 2.50E−2 | −4.30E−3 | 0.00 |
| 7 | −9.38 | 4.74E−2 | −4.58E−2 | 1.79E−2 | −2.95E−3 | 1.74E−4 |
| 8 | 0.00 | −4.55E−2 | 6.00E−3 | −1.46E−3 | 2.90E−4 | −2.30E−5 |

Under such conditions, FL/f₁=1.150 was achieved, thereby satisfying the expression (1). FL/|f₂|=0.788 was achieved, thereby satisfying the expression (2). FL/|f₄|=1.719 was achieved, thereby satisfying the expression (3). (r₇+r₈)/(−r₇+r₈)=0.299 was achieved, thereby satisfying the expression (4).

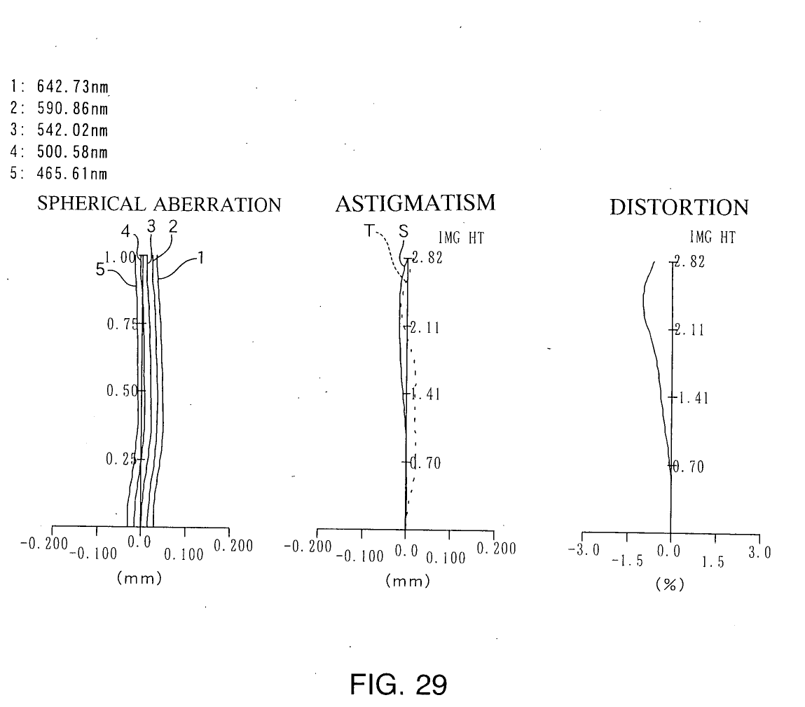

FIG. 29 shows the spherical aberration, the astigmatism and the distortion in the imaging lens 1 of the FOURTEENTH EXAMPLE.

According to the result, each of the spherical aberration, the astigmatism, and the distortion was almost satisfied. It can be seen from the result that a sufficiently excellent optical property can be obtained.

### Fifteenth Example

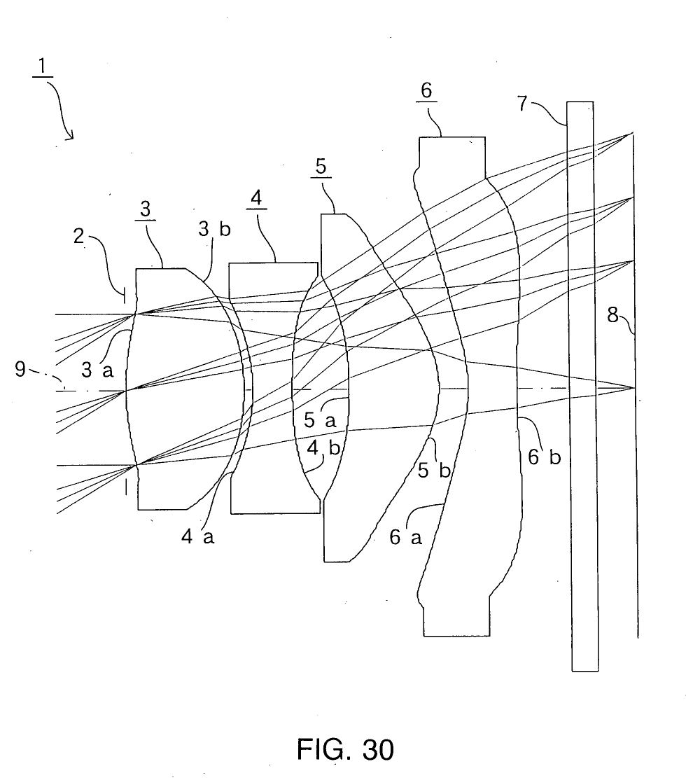

FIG. 30 shows a FIFTEENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the FIFTEENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.810 | 1.35 | 1.6935 | 53.2 |
| (Diaphragm) | | | | |
| 2(Second Face of First Lens) | −2.182 | 0.10 | | |
| 3(First Face of Second Lens) | −1.820 | 0.45 | 1.5850 | 30.0 |
| 4(Second Face of Second Lens) | 7.053 | 0.65 | | |
| 5(First Face of Third Lens) | −3.493 | 1.02 | 1.5310 | 56.0 |
| 6(Second Face of Third Lens) | −1.082 | 0.33 | | |
| 7(First Face of Fourth Lens) | −1.573 | 0.55 | 1.5310 | 56.0 |
| 8(Second Face of Fourth Lens) | 8.876 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −2.54E+1 | 1.19E−1 | −1.67E−1 | 1.40E−1 | −7.79E−2 | 0.00 |
| 2 | 0.00 | −5.82E−2 | 1.70E−2 | −8.78E−3 | −1.90E−3 | 0.00 |
| 3 | 0.00 | 3.78E−2 | −1.30E−2 | 5.32E−3 | 3.20E−3 | 0.00 |
| 4 | 1.05E+1 | 1.04E−1 | −4.17E−2 | 1.44E−2 | 1.39E−3 | 0.00 |
| 5 | 0.00 | −5.86E−2 | 4.55E−2 | −2.19E−2 | 2.08E−3 | 0.00 |
| 6 | −9.45E−1 | 1.18E−1 | −4.64E−2 | 1.68E−2 | −2.37E−3 | 0.00 |
| 7 | −4.50 | 8.48E−2 | −5.20E−2 | 1.63E−2 | −2.62E−3 | 1.67E−4 |
| 8 | 0.00 | −1.26E−2 | −2.94E−3 | 2.20E−4 | 4.22E−5 | −8.03E−6 |

Under such conditions, FL/f₁=2.345 was achieved, thereby satisfying the expression (1). FL/|f₂|=1.931 was achieved, thereby satisfying the expression (2). FL/|f₄|=1.889 was achieved, thereby satisfying the expression (3). (r₇+r₈)/(−r₇+r₈)=0.699 was achieved, thereby satisfying the expression (4).

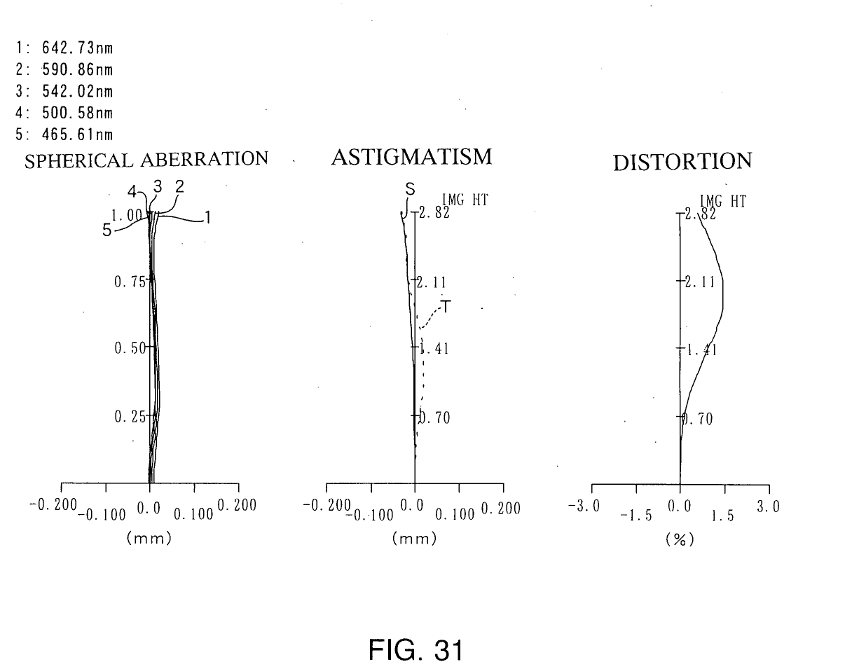

FIG. 31 shows the spherical aberration, the astigmatism and the distortion in the imaging lens 1 of the FIFTEENTH EXAMPLE.

According to the result, each of the spherical aberration, the astigmatism, and the distortion was almost satisfied. It can be seen from the result that a sufficiently excellent optical property can be obtained.

### Sixteenth Example

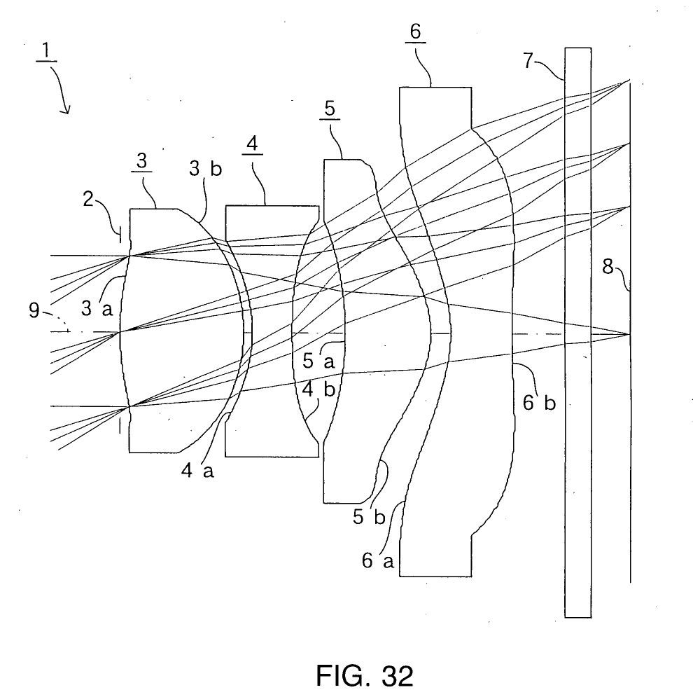

FIG. 32 shows a SIXTEENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the SIXTEENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 2.843 | 1.40 | 1.6935 | 53.2 |
| (Diaphragm) | | | | |
| 2(Second Face of First Lens) | −1.831 | 0.10 | | |
| 3(First Face of Second Lens) | −1.540 | 0.45 | 1.5850 | 30.0 |
| 4(Second Face of Second Lens) | 7.696 | 0.61 | | |
| 5(First Face of Third Lens) | −3.723 | 0.97 | 1.5310 | 56.0 |
| 6(Second Face of Third Lens) | −1.070 | 0.23 | | |
| 7(First Face of Fourth Lens) | −1.500 | 0.69 | 1.5310 | 56.0 |
| 8(Second Face of Fourth Lens) | 9.748 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −3.05E+1 | 1.37E−1 | −2.15E−1 | 2.01E−1 | −1.16E−1 | 0.00 |
| 2 | 0.00 | −2.70E−2 | 8.34E−3 | −9.49E−3 | −4.66E−4 | 0.00 |
| 3 | 0.00 | 1.01E−1 | −4.91E−2 | 1.70E−2 | 5.63E−3 | 0.00 |
| 4 | 1.04E+1 | 1.25E−1 | −6.08E−2 | 2.01E−2 | 1.59E−3 | 0.00 |
| 5 | 0.00 | −4.42E−2 | 4.05E−2 | −1.35E−2 | −7.24E−4 | 0.00 |
| 6 | −1.12 | 1.35E−1 | −7.72E−2 | 3.54E−2 | −5.49E−3 | 0.00 |
| 7 | −5.02 | 5.13E−2 | −4.44E−2 | 1.70E−2 | −2.79E−3 | 1.67E−4 |
| 8 | 0.00 | −2.60E−2 | 9.24E−4 | −4.76E−4 | 9.97E−5 | −1.07E−5 |

Under such conditions, FL/f₁=2.550 was achieved, thereby satisfying the expression (1). FL/|f₂|=2.175 was achieved, thereby satisfying the expression (2). FL/|f₄|=1.948 was achieved, thereby satisfying the expression (3). (r₇+r₈)/(−r₇+r₈)=0.733 was achieved, thereby satisfying the expression (4).

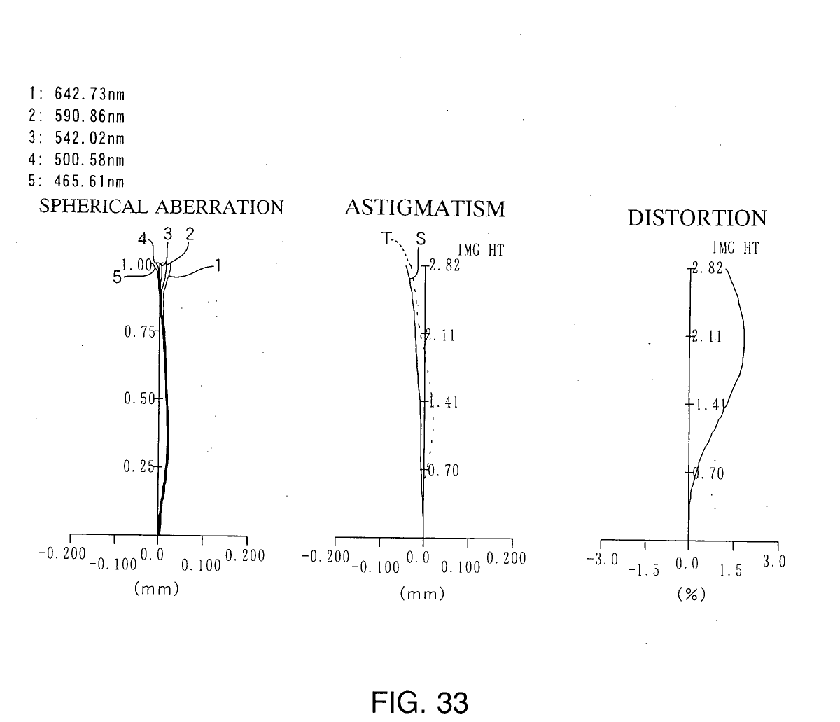

FIG. 33 shows the spherical aberration, the astigmatism and the distortion in the imaging lens 1 of the SIXTEENTH EXAMPLE.

According to the result, each of the spherical aberration, the astigmatism, and the distortion was almost satisfied. It can be seen from the result that a sufficiently excellent optical property can be obtained.

### Seventeenth Example

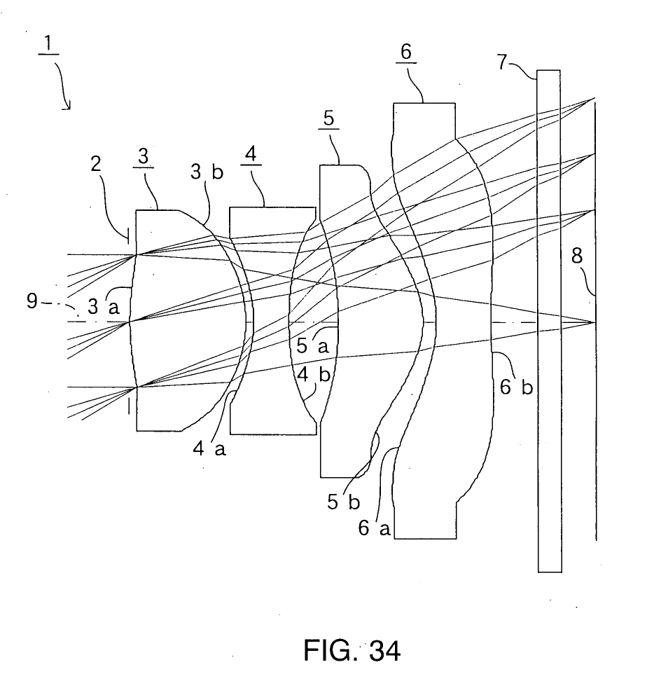

FIG. 34 shows a SEVENTEENTH EXAMPLE of the present invention. In the example, as in the FIRST EXAMPLE, a cover glass serving as the filter 7 is disposed between the second face 6b of the fourth lens 6 and the image-taking surface 8. A position of the diaphragm 2 in the optical axis 9 direction corresponds with a surface peak of the first face 3a of the first lens 3.

The imaging lens 1 of the SIXTEENTH EXAMPLE was set under the following conditions:

Lens Data
FL = 4.65 mm, Fno = 2.8, ω = 31°

| Face Number | r | d | nd | νd |
|---|---|---|---|---|
| (Object Point) | | 8 | | |
| 1(First Face of First Lens) | 3.278 | 1.50 | 1.6935 | 53.2 |
| (Diaphragm) | | | | |
| 2(Second Face of First Lens) | −1.493 | 0.10 | | |
| 3(First Face of Second Lens) | −1.532 | 0.45 | 1.5850 | 30.0 |
| 4(Second Face of Second Lens) | 4.309 | 0.64 | | |
| 5(First Face of Third Lens) | −4.310 | 1.09 | 1.5310 | 56.0 |
| 6(Second Face of Third Lens) | −1.066 | 0.17 | | |
| 7(First Face of Fourth Lens) | −1.511 | 0.70 | 1.5310 | 56.0 |
| 8(Second Face of Fourth Lens) | 9.614 | 0.60 | | |
| 10(First Face of Cover Glass) | 8 | 0.30 | 1.5168 | 64.2 |
| 11(Second Face of Cover Glass) | 8 | | | |
| (Image Surface) | | | | |

| Face Number | k | A | B | C | D | E |
|---|---|---|---|---|---|---|
| 1 | −4.99E+1 | 1.33E−1 | −2.39E−1 | 2.28E−1 | −1.29E−1 | 0.00 |
| 2 | 0.00 | 6.33E−2 | −3.41E−2 | 9.21E−3 | −5.69E−4 | 0.00 |
| 3 | 0.00 | 1.49E−1 | −8.32E−2 | 2.42E−2 | 5.40E−3 | 0.00 |
| 4 | −3.57E+1 | 1.27E−1 | −5.56E−2 | 1.46E−2 | 1.10E−3 | 0.00 |
| 5 | 0.00 | −5.48E−2 | 4.33E−2 | −9.04E−3 | −1.60E−3 | 0.00 |
| 6 | −1.09 | 1.32E−1 | −8.63E−2 | 3.92E−2 | −5.65E−3 | 0.00 |
| 7 | −5.18 | 2.65E−2 | −3.81E−2 | 1.81E−2 | −3.31E−3 | 2.11E−4 |
| 8 | 0.00 | −2.77E−2 | 4.41E−4 | 1.52E−4 | −2.57E−5 | −2.06E−6 |

Under such conditions, FL/f₁=2.750 was achieved, thereby satisfying the expression (1). FL/|f₂|=2.496 was achieved, thereby satisfying the expression (2). FL/|f₄|=1.940 was achieved, thereby satisfying the expression (3). (r₇+r₈)/(−r₇+r₈)=0.728 was achieved, thereby satisfying the expression (4).

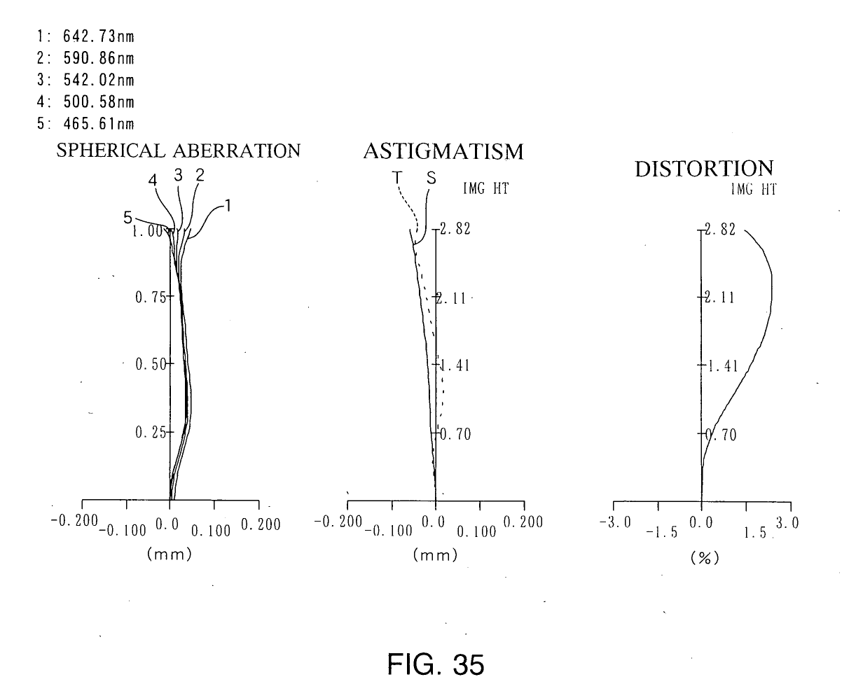

FIG. 35 shows the spherical aberration, the astigmatism and the distortion in the imaging lens 1 of the SEVENTEENTH EXAMPLE.

According to the result, each of the spherical aberration, the astigmatism, and the distortion was almost satisfied. It can be seen from the result that a sufficiently excellent optical property can be obtained.

The present invention is not limited to the above-described embodiment. Various modifications can be made as required.

What is claimed is:

1. An imaging lens comprising:
in order from an object side to an image surface side, a diaphragm, a first lens that is a biconvex lens having a positive power, a second lens having a negative power, a third lens having a positive power, and a fourth lens that is a biconcave lens having a negative power, wherein a condition expressed by a following expression (1) is to be satisfied:
0.7≦FL/f₁≦3.0 (1)
where,
FL: focal distance of the entire lens system
f₁: focal distance of the first lens.

2. An imaging lens according to claim 1, wherein:
a condition expressed by a following expression (2) is to be further satisfied:
0.3≦FL/|f₂|≦2.8 (2)
where,

|f₂|: absolute value of the focal distance of the second lens.

3. An imaging lens according to claim 1, wherein:
a condition expressed by a following expression (3) is to be further satisfied:
1.3≦FL/|f₄|≦2.5 (3)
where,

|f₄ |: absolute value of the focal distance of the fourth lens.

4. An imaging lens according to claim 1, wherein:
a condition expressed by a following expression (4) is to be further satisfied:
0.3≦(r₇+r₈)/(−r₇+r₈)≦1.2 (4)
where,
r₇: center radius curvature of the object side face of the fourth lens
r₈: center radius curvature of the image surface side face of the fourth lens.

5. An imaging device comprising the imaging lens according to any one of claims 1 to 4 and an image sensor element.
